(19) United States
(12) Patent Application Publication
(10) Pub. No.: US 2021/0326871 A1
(43) Pub. Date: Oct. 21, 2021

(54) RESOURCE TRANSFER METHODS, APPARATUSES, DEVICES, AND SYSTEMS

(71) Applicant: ALIPAY (HANGZHOU) INFORMATION TECHNOLOGY CO., LTD., Hangzhou (CN)

(72) Inventor: Rui Zhang, Hangzhou (CN)

(73) Assignee: ALIPAY (HANGZHOU) INFORMATION TECHNOLOGY CO., LTD., Hangzhou (CN)

(21) Appl. No.: 17/362,894

(22) Filed: Jun. 29, 2021

(30) Foreign Application Priority Data
Sep. 17, 2020 (CN) 202010978197.1

(51) Int. Cl. G06Q 20/38; G06Q 20/06

(52) U.S. Cl. CPC G06Q 20/38215; G06Q 20/065; G06Q 20/3825; G06Q 20/3829

(57) ABSTRACT

A resource management institution receives first transfer indication information from a first service institution, where the first transfer indication information is based on a resource transfer request of a user, where the resource transfer request requests a transfer of a resource to a target account controlled by the resource management institution, and where the resource management institution and the first service institution are connected to a blockchain. Transfer information of the resource is generated based on transaction information of a transaction of the user stored on the blockchain. In response to determining that a consensus on the transfer information succeeds, the transfer information is stored on the blockchain, where participants of the consensus include the resource management institution and the first service institution. The resource is transferred, based on the first transfer indication information, to the target account.

### CROSS-REFERENCE TO RELATED APPLICATIONS

This application claims priority to Chinese Patent Application No. 202010978197.1, filed on Sep. 17, 2020, which is hereby incorporated by reference in its entirety.

### TECHNICAL FIELD

The present specification relates to the field of data processing technologies, and in particular, to resource transfer methods, apparatuses, devices, and systems.

### BACKGROUND

With the continuous improvement of the economic level, more and more companies are going international, and cross-border foreign exchange settlement service also continues to increase. Declaration is an important part of the cross-border foreign exchange settlement service, that is, to explain the history of funds to the supervisor. Generally, the declaration is based on the remittance transaction and is time-efficient. There will be serious non-compliance risks once information of the declaration is incorrect, or the declaration operation is not carried out on the same day as the remittance transaction. Therefore, how to handle convenient and reliable cross-border foreign exchange settlement service while meeting compliance requirements is a problem that needs to be solved urgently.

### SUMMARY

One or more embodiments of the present specification provide a resource transfer method applied to a resource management institution. The method includes the following: first transfer indication information sent by a first service institution is received, where the first transfer indication information is sent based on a resource transfer request sent by a first user when it is determined that a predetermined resource transfer condition is satisfied, the resource transfer request is used to request the transfer of a resource to be transferred to a target account controlled by the resource management institution, and the resource management institution and the first service institution are located in different countries and are both connected to a first blockchain; transfer detail information of the resource to be transferred is generated based on transaction information of a first transaction of the first user stored in the first blockchain; the transfer detail information is stored in the first blockchain to supervise, based on the transfer detail information, the transfer of the resource to be transferred, where the transaction information is stored in the first blockchain after consensus verification participated by the resource management institution and the first service institution succeeds; and resource transfer is performed based on the first transfer indication information, so as to transfer the resource to be transferred to the target account.

One or more embodiments of the present specification provide a resource transfer method applied to a first service institution. The method includes the following: a resource transfer request sent by a first user is received, where the resource transfer request is used to request the transfer of a resource to be transferred to a target account controlled by a resource management institution, the first service institution and the resource management institution are located in different countries and are both connected to a first blockchain, and the resource transfer request includes resource transfer information; whether the resource transfer information satisfies a predetermined resource transfer condition is determined; if yes, first transfer indication information is sent to the resource management institution based on the resource transfer information, so the resource management institution stores generated transfer detail information of the resource to be transferred in the first blockchain, and performs resource transfer based on the first transfer indication information, so as to transfer the resource to be transferred to the target account. The transfer detail information is generated based on transaction information of a first transaction of the first user stored in the first blockchain. The transaction information is stored in the first blockchain after the consensus verification participated by the first service institution and the resource management institution succeeds.

One or more embodiments of the present specification provide a resource transfer apparatus applied to a resource management institution. The apparatus includes a receiving module, configured to receive first transfer indication information sent by a first service institution, where the first transfer indication information is sent based on a resource transfer request sent by a first user when it is determined that a predetermined resource transfer condition is satisfied, the resource transfer request is used to request the transfer of a resource to be transferred to a target account controlled by the resource management institution, and the resource management institution and the first service institution are located in different countries and are both connected to a first blockchain. The apparatus further includes a generation module, configured to generate transfer detail information of the resource to be transferred based on transaction information of a first transaction of the first user stored in the first blockchain, and store the transfer detail information in the first blockchain to supervise, based on the transfer detail information, the transfer of the resource to be transferred, where the transaction information is stored in the first blockchain after consensus verification participated by the resource management institution and the first service institution succeeds. The apparatus further includes a transfer module, configured to perform resource transfer based on the first transfer indication information, so as to transfer the resource to be transferred to the target account.

One or more embodiments of the present specification provide a resource transfer apparatus applied to a first service institution. The apparatus includes a receiving module, configured to receive a resource transfer request sent by a first user, where the resource transfer request is used to request the transfer of a resource to be transferred to a target account controlled by a resource management institution, the first service institution and the resource management institution are located in different countries and are both connected to a first blockchain, and the resource transfer request includes resource transfer information. The apparatus further includes a determination module, configured to determine whether the resource transfer information satisfies a predetermined resource transfer condition. The apparatus further includes a sending module, configured to send first transfer indication information to the resource management institution based on the resource transfer information if a determination result of the determination module is yes, so the resource management institution stores generated transfer detail information of the resource to be transferred in the first blockchain, and performs resource transfer based on the first transfer indication information, so as to transfer the resource to be transferred to the target account. The transfer detail information is generated based on transaction information of a first transaction of the first user stored in the first blockchain. The transaction information is stored in the first blockchain after consensus verification participated by the first service institution and the resource management institution succeeds.

One or more embodiments of the present specification provide a resource transfer system. The system includes a first service institution, a resource management institution, and a blockchain system. The first service institution and the resource management institution are located in different countries and are both connected to the blockchain system. The first service institution is configured to receive a resource transfer request sent by a first user, and send first transfer indication information to the resource management institution based on resource transfer information if it is determined that the resource transfer information included in the resource transfer request satisfies a predetermined resource transfer condition, where the resource transfer request is used to request the transfer of a resource to be transferred to a target account controlled by the resource management institution. The resource management institution is configured to receive the first transfer indication information sent by the first service institution, generate transfer detail information of the resource to be transferred based on transaction information of a first transaction of the first user stored in the blockchain system, store the transfer detail information in the blockchain system, and perform resource transfer based on the first transfer indication information, so as to transfer the resource to be transferred to the target account. The transaction information is stored in the blockchain system after consensus verification participated by the resource management institution and the first service institution succeeds. The blockchain system is configured to store the transaction information of the first transaction and the transfer detail information.

One or more embodiments of the present specification provide a resource transfer device. The device includes a processor. The device further includes a memory configured to store computer-executable instructions that, when executed, enable the processor to receive first transfer indication information sent by a first service institution, where the first transfer indication information is sent based on a resource transfer request sent by a first user when it is determined that a predetermined resource transfer condition is satisfied, the resource transfer request is used to request the transfer of a resource to be transferred to a target account controlled by a resource management institution, and the resource management institution and the first service institution are located in different countries and are both connected to a first blockchain; generate transfer detail information of the resource to be transferred based on transaction information of a first transaction of the first user stored in the first blockchain; store the transfer detail information in the first blockchain to supervise, based on the transfer detail information, the transfer of the resource to be transferred, where the transaction information is stored in the first blockchain after consensus verification participated by the resource management institution and the first service institution succeeds; and perform resource transfer based on the first transfer indication information, so as to transfer the resource to be transferred to the target account.

One or more embodiments of the present specification provide a resource transfer device. The device includes a processor. The device further includes a memory configured to store computer-executable instructions that, when executed, enable the processor to receive a resource transfer request sent by a first user, where the resource transfer request is used to request the transfer of a resource to be transferred to a target account controlled by a resource management institution, the first service institution and the resource management institution are located in different countries and are both connected to a first blockchain, and the resource transfer request includes resource transfer information; determine whether the resource transfer information satisfies a predetermined resource transfer condition; if yes, send first transfer indication information to the resource management institution based on the resource transfer information, so the resource management institution stores generated transfer detail information of the resource to be transferred in the first blockchain, and performs resource transfer based on the first transfer indication information, so as to transfer the resource to be transferred to the target account. The transfer detail information is generated based on transaction information of a first transaction of the first user stored in the first blockchain. The transaction information is stored in the first blockchain after consensus verification participated by the first service institution and the resource management institution succeeds.

One or more embodiments of the present specification provide a storage medium configured to store computer-executable instructions that, when executed by a processor, are used to receive first transfer indication information sent by a first service institution, where the first transfer indication information is sent based on a resource transfer request sent by a first user when it is determined that a predetermined resource transfer condition is satisfied, the resource transfer request is used to request the transfer of a resource to be transferred to a target account controlled by a resource management institution, and the resource management institution and the first service institution are located in different countries and are both connected to a first blockchain; generate transfer detail information of the resource to be transferred based on transaction information of a first transaction of the first user stored in the first blockchain; store the transfer detail information in the first blockchain to supervise, based on the transfer detail information, the transfer of the resource to be transferred, where the transaction information is stored in the first blockchain after consensus verification participated by the resource management institution and the first service institution succeeds; and perform resource transfer based on the first transfer indication information, so as to transfer the resource to be transferred to the target account.

One or more embodiments of the present specification provide a storage medium configured to store computer-executable instructions that, when executed by a processor, are used to receive a resource transfer request sent by a first user, where the resource transfer request is used to request the transfer of a resource to be transferred to a target account controlled by a resource management institution, the first service institution and the resource management institution are located in different countries and are both connected to a first blockchain, and the resource transfer request includes resource transfer information; determine whether the resource transfer information satisfies a predetermined resource transfer condition; if yes, send first transfer indication information to the resource management institution based on the resource transfer information, so the resource management institution stores generated transfer detail information of the resource to be transferred in the first blockchain, and performs resource transfer based on the first transfer indication information, so as to transfer the resource to be transferred to the target account. The transfer detail information is generated based on transaction information of a first transaction of the first user stored in the first blockchain. The transaction information is stored in the first blockchain after consensus verification participated by the first service institution and the resource management institution succeeds.

### BRIEF DESCRIPTION OF DRAWINGS

In order to describe one or more embodiments of the present specification or the technical solutions in the existing technology more clearly, drawings needed to be used in the embodiments or the illustration of the existing technology will be briefly introduced below. Clearly, the drawings in the illustration below are only some embodiments in the present specification. Those ordinarily skilled in the art further can obtain other drawings based on these drawings without creative efforts.

FIG. 1 is a schematic diagram illustrating a first scenario of a resource transfer method, according to one or more embodiments of the present specification;

FIG. 2 is a schematic diagram illustrating a second scenario of a resource transfer method, according to one or more embodiments of the present specification;

FIG. 3 is a first schematic flowchart illustrating a resource transfer method, according to one or more embodiments of the present specification;

FIG. 4 is a second schematic flowchart illustrating a resource transfer method, according to one or more embodiments of the present specification;

FIG. 5 is a third schematic flowchart illustrating a resource transfer method, according to one or more embodiments of the present specification;

FIG. 6 is a fourth schematic flowchart illustrating a resource transfer method, according to one or more embodiments of the present specification;

FIG. 7 is a fifth schematic flowchart illustrating a resource transfer method, according to one or more embodiments of the present specification;

FIG. 8 is a sixth schematic flowchart illustrating a resource transfer method, according to one or more embodiments of the present specification;

FIG. 9 is a seventh schematic flowchart illustrating a resource transfer method, according to one or more embodiments of the present specification;

FIG. 10 is an eighth schematic flowchart illustrating a resource transfer method, according to one or more embodiments of the present specification;

FIG. 11 is a ninth schematic flowchart illustrating a resource transfer method, according to one or more embodiments of the present specification;

FIG. 12 is a tenth schematic flowchart illustrating a resource transfer method, according to one or more embodiments of the present specification;

FIG. 13 is an eleventh schematic flowchart illustrating a resource transfer method, according to one or more embodiments of the present specification;

FIG. 14 is a schematic diagram illustrating first assembly of a resource transfer apparatus, according to one or more embodiments of the present specification;

FIG. 15 is a schematic diagram illustrating second assembly of a resource transfer apparatus, according to one or more embodiments of the present specification;

FIG. 16 is a schematic diagram illustrating first assembly of a resource transfer system, according to one or more embodiments of the present specification;

FIG. 17 is a schematic diagram illustrating second assembly of a resource transfer system, according to one or more embodiments of the present specification;

FIG. 18 is a schematic diagram illustrating third assembly of a resource transfer system, according to one or more embodiments of the present specification; and

FIG. 19 is a schematic structural diagram illustrating a resource transfer device, according to one or more embodiments of the present specification.

### DESCRIPTION OF EMBODIMENTS

In order to enable those skilled in the art to better understand the technical solutions in one or more embodiments of the present specification, the technical solutions in one or more embodiments of the present specification will be described clearly and comprehensively below in combination with the accompanying drawings in one or more embodiments of the present specification. Clearly, the embodiments described are only a part of the embodiments in the present specification, rather than all the embodiments. Based on one or more embodiments of the present specification, all other embodiments obtained by those of ordinary skill in the art without creative work shall fall within the protection scope of the present specification.

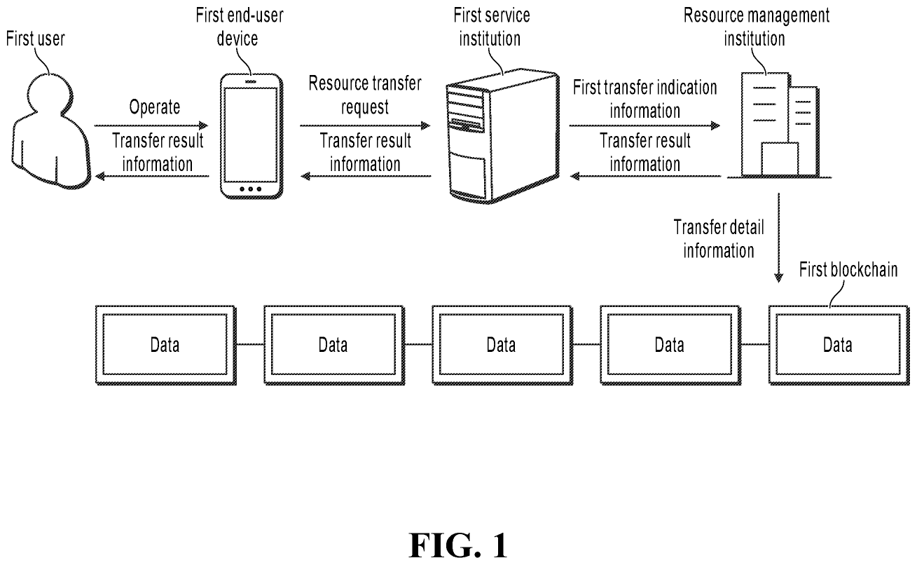

FIG. 1 is a schematic diagram illustrating an application scenario of a resource transfer method, according to one or more embodiments of the present specification. As shown in FIG. 1, the scenario includes a first end-user device of a first user, a resource management institution, a first service institution, and a first blockchain. The first end-user device can be a mobile phone, a tablet computer, a desktop computer, a portable notebook computer, etc. The resource management institution and the first service institution are located in different countries, and are both deployed with node devices connected to the first blockchain (not shown in FIG. 1). The resource management institution and the first service institution can access the first blockchain through their respective node devices to participate in consensus verification, etc. The node devices deployed in the resource management institution and the first service institution can be end-user devices, such as mobile phones, tablet computers, desktop computers, portable notebook computers, etc., and can further be independent servers or server clusters composed of a plurality of servers. The first blockchain stores data, such as transaction information of a first transaction of the first user, transfer detail information, etc.

Specifically, the first user operates the first end-user device to send a resource transfer request to the first service institution when needing to transfer the first user's resource in a country where the first service institution is located to a target account in the country where the resource management institution is located. The first service institution receives the resource transfer request, and sends first transfer indication information to the resource management institution based on resource transfer information when determining the resource transfer information included in the resource transfer request satisfies a predetermined resource transfer condition. The resource management institution generates transfer detail information of the resource to be transferred based on transaction information of a first transaction of the first user stored in the first blockchain when receiving the first transfer indication information sent by the first service institution; stores the generated transfer detail information in the first blockchain; and performs resource transfer based on the first transfer indication information, so as to transfer the resource to be transferred to a target account. The resource management institution sends transfer result information to the first service institution so that the first service institution sends the transfer result information to the first end-user device, and the first end-user device displays the received transfer result information. The transaction information is stored in the first blockchain after consensus verification participated by the resource management institution and the first service institution succeeds.

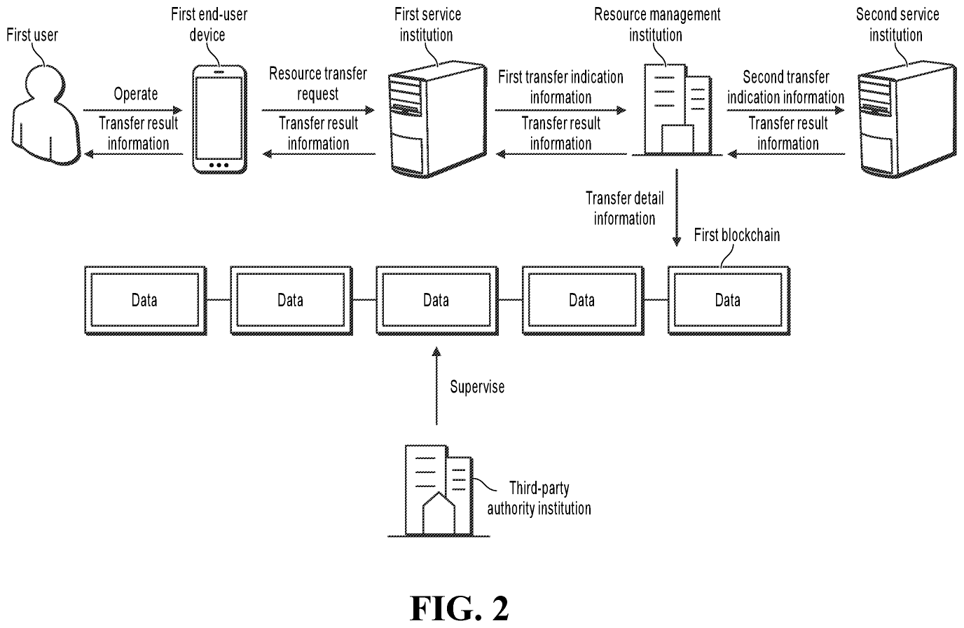

Further, as shown in FIG. 2, the scenario can further include a second service institution and a third-party authority institution that are located in the same country as the resource management institution, where the second service institution and the third-party authority institution are both deployed with node devices (not shown in FIG. 2) connected to the first blockchain. The second service institution and the third-party authority institution can participate in consensus verification through their respective node devices, for example, participate in the consensus verification on the transaction information of the first transaction of the first user. Further, the resource management institution can transfer the resource to be transferred to a first account of the second service institution based on the first transfer indication information, and send second transfer indication information to the second service institution; the second service institution transfers the resource to be transferred from the first account to the target account based on the received second transfer indication information, and sends transfer result information to the resource management institution; the resource management institution sends the received transfer result information to the first service institution so that the first service institution sends the transfer result information to the first end-user device; and the first end-user device displays the received transfer result information. The third-party authority institution can supervise the corresponding resource transfer based on the transfer detail information in the first blockchain to determine whether the corresponding resource transfer is valid. In order to facilitate distinguishing all the node devices, the node device of the resource management institution can be denoted as a first node device, the node device of the first service institution can be denoted as a second node device, and the node device of the second service institution can be denoted as a third node device, and the node device of the third-party authority institution can be denoted as a fourth node device. All the following operations are performed by the node devices of the various institutions.

Therefore, various participants in the resource transfer are connected to the first blockchain, and the transaction information of the first transaction of the first user is verified through consensus and then stored in the blockchain before the first user initiates the resource transfer request. Therefore, the time cost needed by transmitting data layer by layer between the various participants is reduced, and additional operations such as verification performed by the layer-by-layer data transmission between the various participants are reduced, thereby reducing the data processing cost of the various participants, improving the processing efficiency of resource transfer and ensuring the timeliness; and moreover, the transaction information is stored in the blockchain after the consensus verification to ensure the authenticity and reliability of the transaction information, thereby ensuring the reliability of the transfer detail information generated based on the transaction information and providing an effective basis and convenience for subsequent compliance supervision.

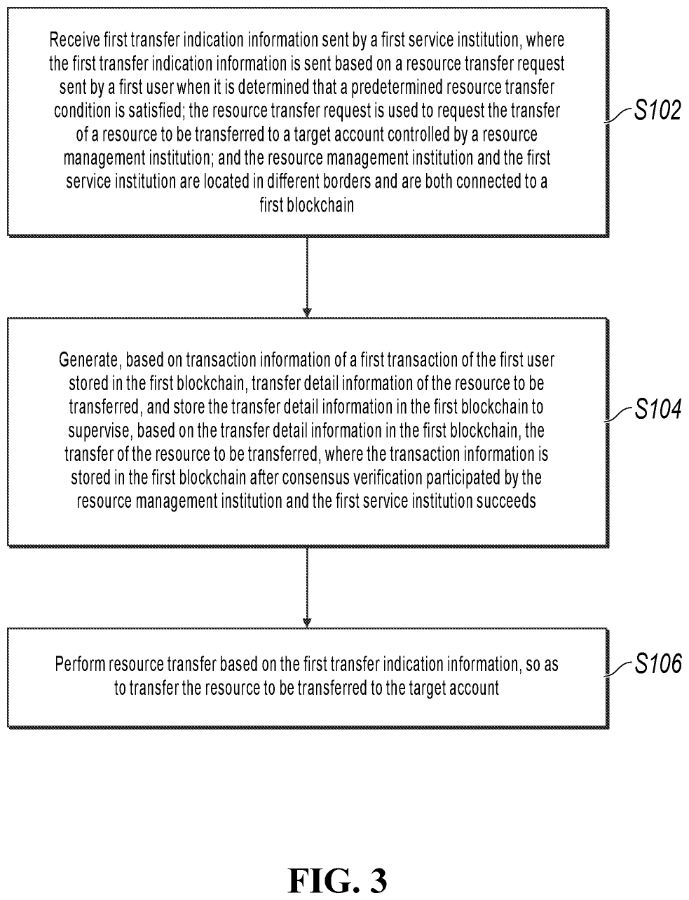

FIG. 3 is a schematic flowchart illustrating a resource transfer method, according to one or more embodiments of the present specification. The method in FIG. 3 can be performed by the resource management institution in FIG. 1. As shown in FIG. 3, the method includes the following steps.

At S102, first transfer indication information sent by a first service institution is received, where the first transfer indication information is sent based on a resource transfer request sent by a first user when it is determined that a predetermined resource transfer condition is satisfied; the resource transfer request is used to request the transfer of a resource to be transferred to a target account controlled by the resource management institution; and the resource management institution and the first service institution are located in different countries and are both connected to a first blockchain.

Specifically, the first user operates first user's first end-user device to send the resource transfer request to the first service institution when needing to transfer first user's resource in a country where the first service institution is located to the target account in a country where the resource management institution is located. The first service institution determines whether resource transfer information included in the resource transfer request satisfies the predetermined resource transfer condition when receiving the resource transfer request, if no, sends request failure information to the first user, and if yes, sends the first transfer indication information to the resource management institution based on the resource transfer information. The resource transfer information includes a first quantity of the resources to be transferred, account information of the target account, user identifier information of the first user, etc. The resource to be transferred can be either a physical resource such as currency or a virtual resource such as points and electronic currency.

At S104, transfer detail information of the resource to be transferred is generated based on transaction information of a first transaction of the first user stored in the first blockchain, and the transfer detail information is stored in the first blockchain to supervise, based on the transfer detail information in the first blockchain, the transfer of the resource to be transferred, where the transaction information is stored in the first blockchain after consensus verification participated by the resource management institution and the first service institution succeeds.

The first transaction is a transaction performed during the first user sends the resource transfer request, and the transaction information varies with the type of the transaction. The transfer detail information can include all information in the transaction information, or include part of the information in the transaction information. The present specification does not specifically limit this.

Generally, the types of resources in different countries are different. Illustration is made by taking the resource to be transferred as a first type of resource. In order to be able to explain history such as a source of the resource to be transferred in the subsequent supervision process, a resource transferred in the first transaction of the first user includes the first type of resource, and the transaction information includes a second quantity of the first type of resources transferred in the first transaction of the first user, etc. As an example, the first user opens a store and sells products on an e-commerce platform in the country where the first service institution is located. One first transaction is constructed when the first user sells one product. Correspondingly, the transaction information can include the transaction time, product information, a product price (i.e., the second quantity), product logistics information, etc. As another example, the first user works in a company in the country where the first service institution is located, and one first transaction is constructed when the company transfers a salary to an account of the first user in the country each month. Correspondingly, the transaction information can include the transaction time, a transfer amount (i.e., the second quantity), payer's account information, company information, etc.

At S106, resource transfer is performed based on the first transfer indication information, so as to transfer the resource to be transferred to the target account.

In one or more embodiments of the present specification, the resource management institution receives the first transfer indication information sent by the first service institution located in a different country, where the first transfer indication information is sent based on the resource transfer request sent by the first user; generates, based on the transaction information of the first transaction of the first user stored in the accessed first blockchain, the transfer detail information of the resource to be transferred and stores the transfer detail information in the first blockchain to supervise the transfer of the resource to be transferred based on the transfer detail information in the first blockchain; and performs the resource transfer based on the first transfer indication information, so as to transfer the resource to be transferred to the target account, where the transaction information is stored in the first blockchain after the consensus verification participated by the resource management institution and the first service institution succeeds. Therefore, various participants in the resource transfer are connected to the first blockchain, and perform the consensus verification on the transaction information of the first transaction of the first user and then store the transaction information in the first blockchain before the first user initiates the resource transfer request. Therefore, the time cost needed by transmitting data such as the transaction information layer by layer between the various participants is reduced, and additional operations such as verification performed by the layer-by-layer data transmission between the various participants are reduced, thereby reducing the data processing cost of the various participant and improving the processing efficiency of resource transfer; moreover, the transfer detail information can be fast generated based on the transaction information in the blockchain, thereby ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

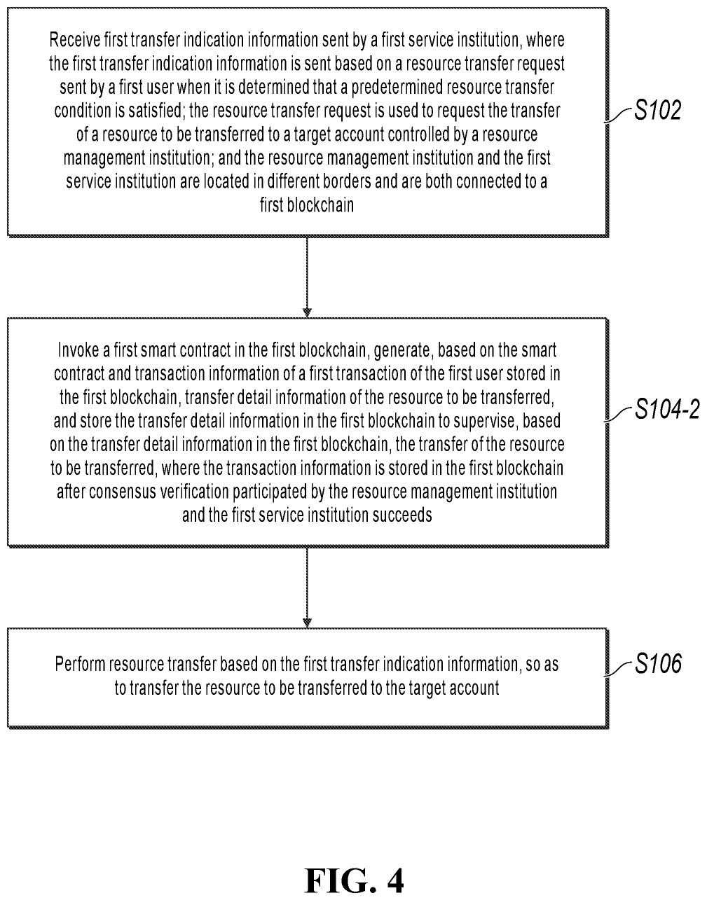

In order to improve the generation rate of the transfer detail information, in one or more embodiments of the present specification, a first smart contract is deployed in the first blockchain in advance, and the transfer detail information is generated based on the first smart contract. Specifically, as shown in FIG. 4, S104 can include following S104-2.

At S104-2, a first smart contract in the first blockchain is invoked; the transfer detail information of the resource to be transferred is generated based on the first smart contract and the transaction information of the first transaction of the first user stored in the first blockchain; and the transfer detail information is stored in the first blockchain to supervise, based on the transfer detail information in the first blockchain, the transfer of the resource to be transferred, where the transaction information is stored in the first blockchain after the consensus verification participated by the resource management institution and the first service institution succeeds.

The transfer detail information is generated through a smart contract, without human involvement and without interactions between the various institutions, thereby increasing the generation rate of the transfer detail information. Especially for supervision with a timeliness requirement (such as declaration of cross-border foreign exchange settlement service), the supervision requirements can be better satisfied, and the risk of non-compliance is avoided.

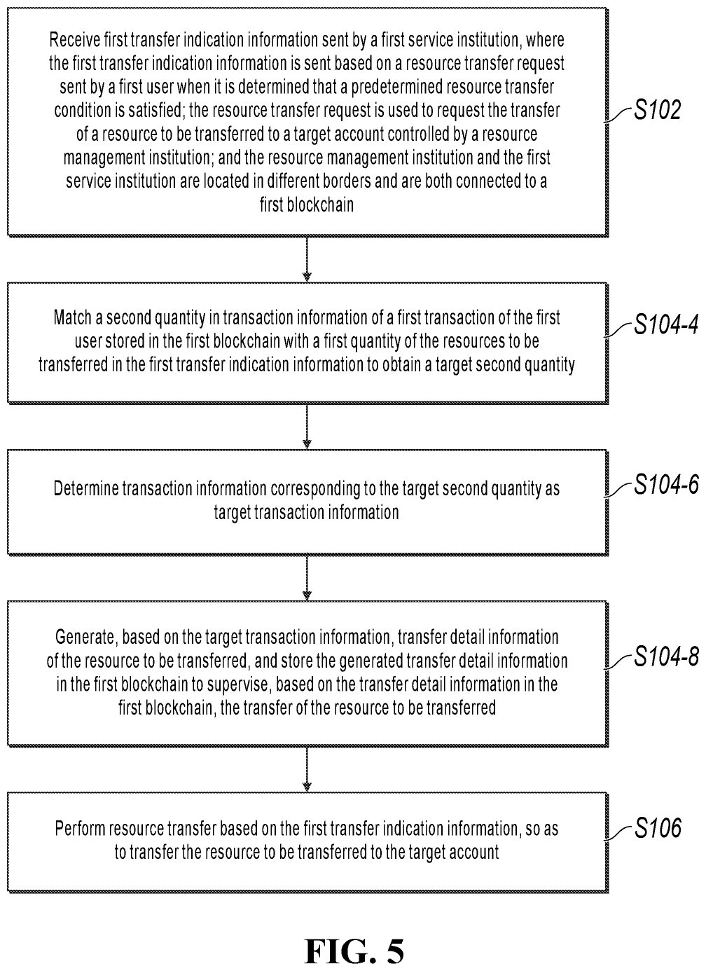

Considering that when the resource to be transferred actually corresponds to a plurality of first transactions, transaction information of the plurality of first transactions needed to be queried one by one from the first blockchain if the transfer detail information is generated based on the transaction information of the plurality of first transactions. A plurality of query operations will decrease the generation rate of the transfer detail information as each query is time-consuming. For example, the resource to be transferred is 20,000 points, which actually corresponds to 50 first transactions. Transaction information of the 50 first transactions needs to be queried from the first blockchain in turn, and then the transfer detail information is generated based on the transaction information of the 50 first transactions. It takes time for 50 query operations, so the generation rate of the transfer detail information will be decreased. Based on this, in one or more embodiments of the present specification, target transaction information can be obtained by matching the first quantity of the resources to be transferred with the second quantity in the transaction information, without corresponding to an actual transaction. Specifically, as shown in FIG. 5, S104 can include following S104-4 to S104-8.

At S104-4, the second quantity in the transaction information of the first transaction of the first user stored in the first blockchain is matched with the first quantity of the resources to be transferred in the first transfer indication information to obtain a target second quantity.

Specifically, associated transaction information is obtained from the first blockchain based on the user identifier information of the first user included in the first transfer indication information, and the second quantity in the obtained transaction information is matched with the first quantity of the resources to be transferred to obtain the target second quantity. There can be one or more target second quantities. The matching method can be set in practice as needed. As an example, the matching method can include: a second quantity in transaction information obtained first is matched with the first quantity based on the acquisition sequence of all the transaction information, so as to increase the matching rate; a second quantity with a relatively large value in the obtained transaction information is matched with the first quantity when the first quantity is relatively large, so that the subsequently generated transfer detail information would not include much information for convenience for searching the transfer detail information; and a second quantity can be split, etc. when the second quantity in the transaction information is greater than the first quantity. It is worthwhile to note that it is necessary to ensure that part of the quantities of the generated transfer detail information are not repeatedly used when the second quantity is split.

For example, the resource to be transferred refers to points. Corresponding transactions are sequentially denoted as transaction 1, transaction 2, transaction 3, transaction 4, and transaction 5 based on the acquisition sequence of the transaction information. The second quantities included in the corresponding transaction information are 20, 50, 90, 30, and 40; the first quantity of the resources to be transferred is 70; the resource to be transferred actually corresponds to transaction 4 and transaction 5; in the matching process, the second quantities in the obtained transaction information can first be matched with the first quantity to obtain the target second quantities 20 and 50; and the second quantities in the transaction information can further be split to obtain the target second quantities 90, etc.

At S104-6, transaction information corresponding to the target second quantity is determined as target transaction information.

At S104-8, the transfer detail information of the resource to be transferred is generated based on the target transaction information, and the generated transfer detail information is stored in the first blockchain to supervise, based on the transfer detail information in the first blockchain, the transfer of the resource to be transferred.

Specifically, the generated transfer detail information is stored in the first blockchain so that the third-party authority institution supervises, based on the transfer detail information in the first blockchain, the transfer of the resource to be transferred. Therefore, the target transaction information is determined by matching the second quantity with the first quantity when the supervision rules do not require that the resource to be transferred needs to correspond to an actual first transaction, so that the determination rate of the target transaction information can be increased, and then the generation rate of the transfer detail information is increased.

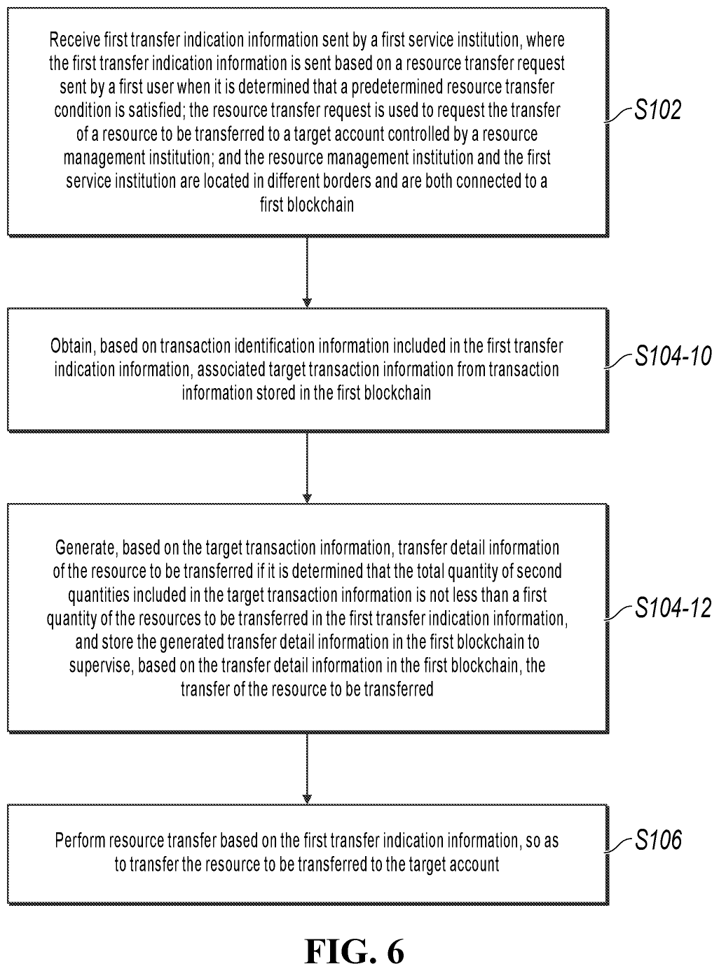

Further, in one or more embodiments of the present specification, the first transfer indication information can include the first quantity of the resources to be transferred and transaction identifier information of the first transaction corresponding to the resource to be transferred when the supervision rules or other factors require that the resource to be transferred needs to correspond to the actual first transaction. Specifically, as shown in FIG. 6, S104 can further include following S104-10 and S104-12.

At S104-10, associated target transaction information is obtained, based on the transaction identifier information included in the first transfer indication information, from the transaction information stored in the first blockchain, where there can be one or more pieces of transaction identifier information included in the first transfer indication information.

At S104-12, the transfer detail information of the resource to be transferred is generated based on the target transaction information if it is determined that the total quantity of the second quantities included in the target transaction information is not less than the first quantity of the resources to be transferred in the first transfer indication information; and the generated transfer detail information is stored in the first blockchain to supervise, based on the transfer detail information in the first blockchain, the transfer of the resource to be transferred.

Therefore, the transfer detail information is generated based on the target transaction information associated with the transaction identifier information when the first transfer indication information includes the transaction identifier information, so that the resource to be transferred can be enabled to correspond to the actual first transaction to satisfy the relevant supervision requirements and facilitate managing the transactions.

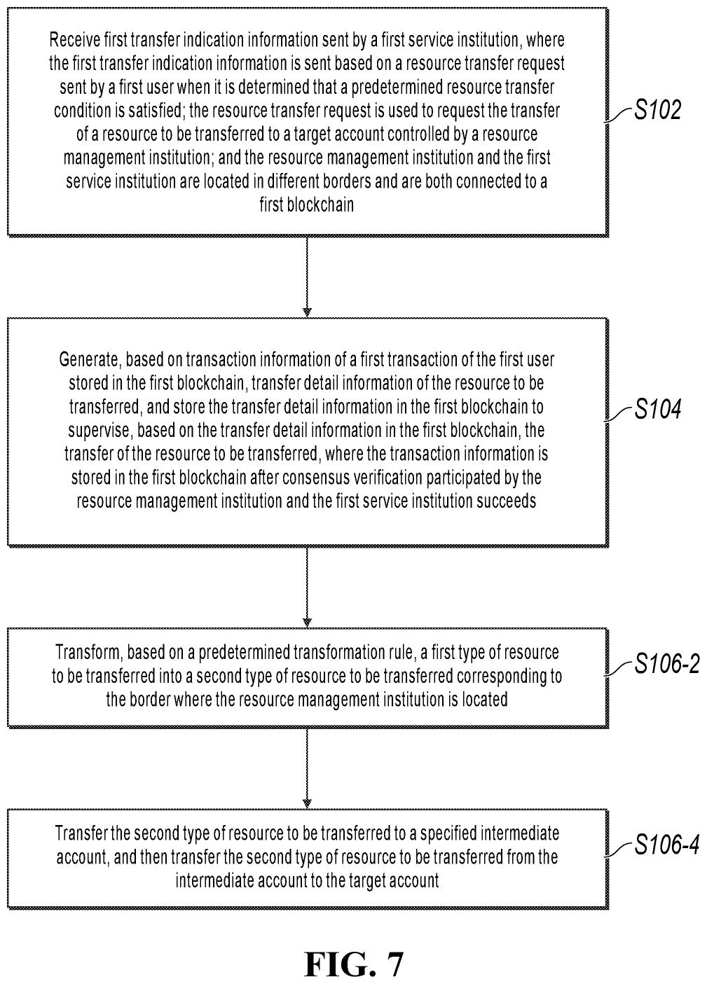

Considering that the types of resources in different countries are often different, based on this, in one or more embodiments of the present specification, the type of a resource is firstly transformed during the resource transfer. Specifically, as shown in FIG. 7, S106 includes the following steps.

At S106-2, the first type of resource to be transferred is transformed, based on a predetermined transformation rule, into a second type of resource to be transferred corresponding to the country where the resource management institution is located, where the transformation rule can vary based on different resources to be transferred. For example, a current exchange rate is obtained if the resource to be transferred is currency, and the resource transformation is performed based on the obtained exchange rate. For another example, the resource transformation can be performed based on a predetermined transformation rule is the resource to be transferred is a point.

At S106-4, the second type of resource to be transferred is transferred to a specified intermediate account based on the first transfer indication information, and then is transferred from the intermediate account to the target account.

Optionally, participants in the resource transfer further include a second service institution located in the same country as the resource management institution. Correspondingly, the resource management institution transfers, based on the first transfer indication information, the second type of resource to be transferred obtained by transformation to a first account of the second service institution, and sends second transfer indication information to the second service institution so that the second service institution transfers the second type of resource to be transferred from the first account to the target account based on the second transfer indication information. Specifically, the resource management institution transfers a fourth quantity of the second type of resources obtained by transformation to the corresponding first account based on predetermined account information of the second service institution, and sends the second transfer indication information to the second service institution based on account information of the target account included in the first transfer indication information and the fourth quantity; and the second service institution transfers the fourth quantity of the second type of resource to be transferred from the first account to the target account based on the received second transfer indication information.

Alternatively, the resource management institution transfers the second type of resource to be transferred obtained by transformation to a second account of the resource management institution, and transfers the second type of resource to be transferred from the second account to the target account.

Transforming the first type of resource to be transferred into the second type of resource to be transferred corresponding to the country where the resource management institution is located and transferring the second type of resource to be transferred to the target account not only can facilitate users to operate the resources in the target account and also facilitate the third-party authority institution in the country where the resource management institution is located to supervise the resources.

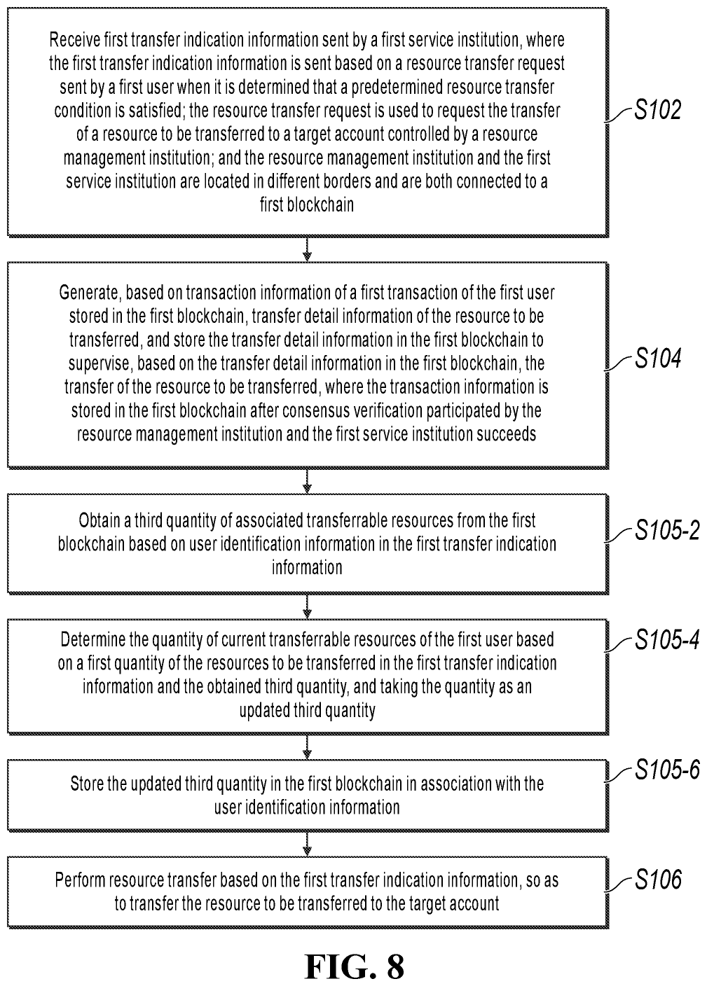

Generally, the quantity of the resources to be transferred cannot be greater than the total quantity of the second quantities in the transaction information. The second quantity that participates in the generation of the transfer detail information cannot participate in the generation of other transfer detail information again. Based on this, in one or more embodiments of the present specification, a third quantity of transferrable resources of the first user is determined based on the second quantity in the transaction information after the transaction information that succeeds in consensus verification; and the resource management institution updates the third quantity when the transfer of the resource to be transferred is completed. Specifically, as shown in FIG. 8, after S104, the method can further include the following steps.

At S105-2, a third quantity of associated transferrable resources is obtained from the first blockchain based on the user identifier information in the first transfer indication information, where the third quantity is the quantity of the transferrable resources of the first user that is determined based on the first quantity of the resources to be transferred after a node device having a data process permission stores the transaction information in the first blockchain.

At S105-4, the quantity of current transferrable resources of the first user is determined based on the first quantity of the resources to be transferred in the first transfer indication information and the obtained third quantity, and is used as an updated third quantity.

Specifically, a result obtained by subtracting the first quantity from the obtained third quantity is determined as the updated third quantity.

At S105-6, the updated third quantity is stored in the first blockchain in association with the user identifier information.

It is worthwhile to note that S105-2 to S105-6 can further be performed after S106. Updating the third quantity ensures the accuracy of the third quantity, so that the first service institution can accurately determine, based on a current third quantity, whether the resource transfer request satisfies the resource transfer condition when receiving the resource transfer request sent by the first user, and then perform corresponding processing, ensuring effective resource transfer.

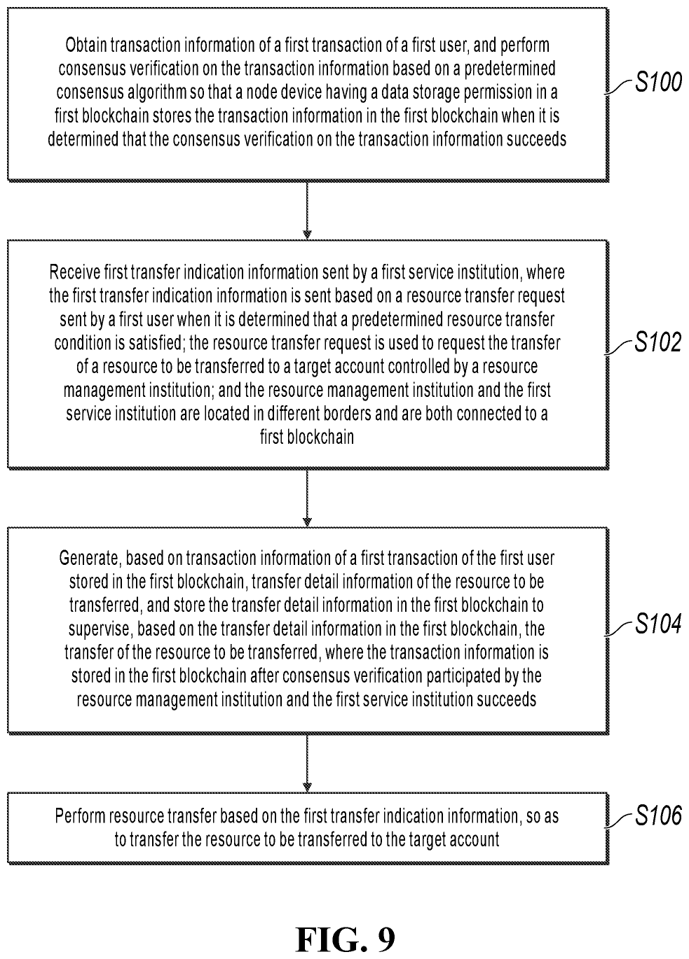

In order to guarantee the accuracy of the transfer detail information generated based on the transaction information of the first transaction of the first user and improve the generation efficiency of the transfer detail information, in one or more embodiments of the present specification, each node device connected to the first blockchain performs consensus verification on the transaction information, and stores the transaction information in the first blockchain after the consensus verification succeeds. Specifically, as shown in FIG. 9, before S102, the method can further include the following steps.

At S100, the transaction information of the first transaction of the first user is obtained, and the consensus verification is performed on the transaction information based on a predetermined consensus algorithm so that the node device that is permitted to store data in the first blockchain stores the transaction information in the first blockchain when it is determined that the consensus verification on the transaction information succeeds.

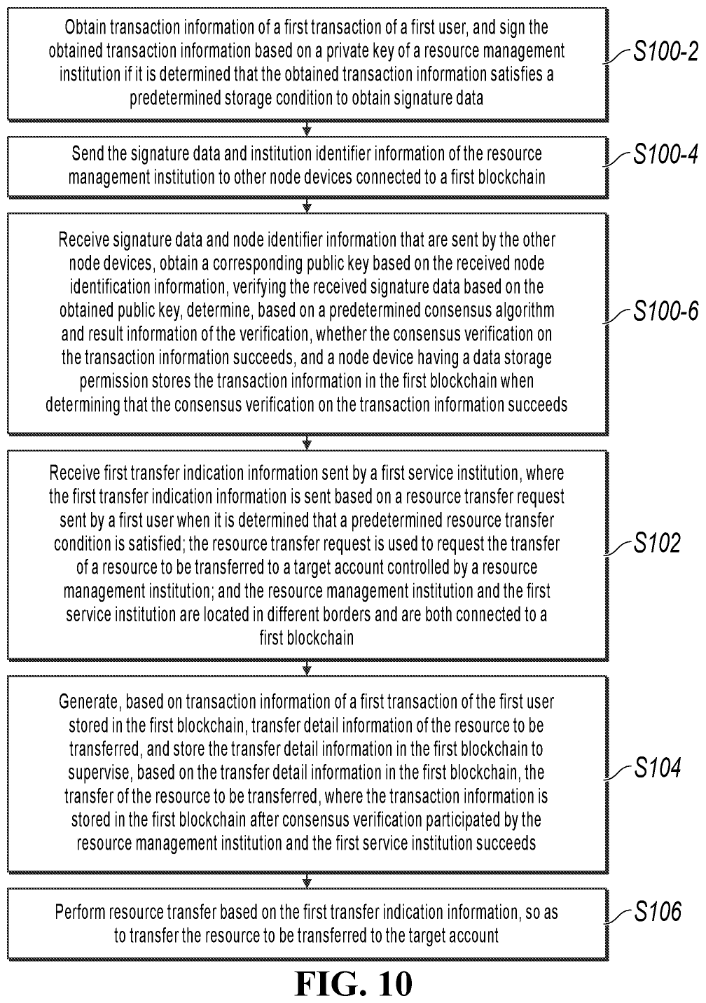

Specifically, as shown in FIG. 10, S100 can include the following steps.

At S100-2, the transaction information of the first transaction of the first user is obtained, and the obtained transaction information is signed based on a private key of the resource management institution if it is determined that the obtained transaction information satisfies a predetermined storage condition to obtain signature data.

Optionally, the first service institution obtains the transaction information of the first transaction of the first user based on a predetermined method, and broadcasts the obtained transaction information in the first blockchain through the second node device deployed in the first service institution. For example, the first user opens a store and sells products on a certain e-commerce platform, and the first service institution obtains the transaction information of the first transaction of the first user through an open interface of the e-commerce platform; or the first user broadcasts the transaction information of the first transaction in the first blockchain through first user's node device when the first user deploys a node device connected to the first blockchain; or the first user sends the transaction information of first user's first transaction to a connected node device in connected first blockchain, and the node device broadcasts the received transaction information in the first blockchain. The resource management institution obtains the transaction information broadcast in the first blockchain through the first node device deployed by the resource management institution; and signs the obtained transaction information based on the private key of the resource management institution if determining that the obtained transaction information satisfies the predetermined condition.

Further, the determining that the obtained information satisfies the predetermined storage condition includes the following: determining that the transaction information satisfies the predetermined storage condition if it is determined that the format of the transaction information satisfies a predetermined format, the first transaction corresponding to the transaction information is of a predetermined transaction type, and the first transaction corresponding to the transaction information is a valid transaction.

Much further, no signature data is sent to other node devices if it is determined that the obtained transaction information does not satisfy the predetermined storage condition. Each node device in the first blockchain determines that the consensus verification on the transaction information fails when not receiving the signature data sent by the other node devices within a predetermined duration or the received signature data is less than a predetermined quantity, so the corresponding transaction information will not be stored in the first blockchain.

Specifically, in order to facilitate each node device to perform the consensus verification on the transaction information and have the same verification logic, the format of the transaction information is predetermined. The format of the transaction information can be set as needed in practice. In order to avoid illegal transactions (such as drug transactions, firearms transactions, etc.) that result in non-compliance during supervision, types of legal transactions (transactions other than the illegal transactions) are predetermined; and in order to avoid false transactions, the authenticity of the first transaction is verified based on the transaction information, for example, whether an order number in the transaction information is valid is determined, whether logistics information in the transaction information is valid is determined, whether a corresponding product exists is determined based on product information in the transaction information, whether a corresponding company exists is determined based on company information in the transaction information, etc. The verification rules for valid transactions can also be set as needed in practice. Therefore, the occurrence of the false transactions and the illegal transactions is prevented through the verification on the transaction information, thereby lowering the risk of non-compliance in the subsequent supervision process.

At S100-4, the signature data and institution identifier information of the resource management institution are sent to other node devices connected to the first blockchain.

The institution identifier information can be regarded as node identifier information of the first node device of the resource management institution; the other node devices obtain a corresponding public key from a specified association relationship between the node identifier information and the public key based on the institution identifier information when receiving the signature data and the institution identifier information; and perform verification on the signature data based on the obtained public key; and determine whether the consensus verification on the transaction information succeeds based on a predetermined consensus algorithm and result information of the verification. The consensus algorithm can be any existing consensus algorithm that can be set as needed in practice. For example, the total quantity of the node devices connected to the first blockchain is set to be n; and it is determined that the consensus verification on the transaction information succeeds when a verification result of verification on 0.7*n pieces of signature data succeeds.

At S100-6, signature data and node identifier information that are sent by the other node devices are received; a corresponding public key is obtained based on the received node identifier information; the received signature data is verified based on the obtained public key; whether the consensus verification on the transaction information succeeds is determined based on the predetermined consensus algorithm and result information of the verification; and the node device having a data storage permission stores the transaction information in the first blockchain when determining that the consensus verification on the transaction information succeeds.

The way that the resource management institution determines whether the consensus verification on the transaction information succeeds is the same as the previously described way that the other node devices determine whether the consensus verification on the transaction information succeeds, and details are omitted here for simplicity. Further, the node device having a data storage permission can be a node device elected by the various node devices through voting, or a predetermined node device, or each various node device can be the node device having a data storage permission based on a predetermined order and a duration. The way to determine the node device having a data storage permission is not specifically limited in the present specification, and can be set as needed in practice.

Further, the node device having a data storage permission further obtains the third quantity of the associated transferrable resources from the first blockchain based on the user identifier information in the transaction information after storing the transaction information in the first blockchain, adds the second quantity in the transaction information to the obtained third quantity, determines a result of the addition as the updated third quantity, and stores the updated third quantity in the first blockchain in association with the user identifier information.

Therefore, through the consensus verification on the transaction information, the time cost required by layer-by-layer transmission of the transaction information between the various institutions is reduced, the efficiency of resource transfer is improved, and the timeliness is guaranteed; and furthermore, the authenticity and the reliability of the transaction information are ensured, thereby ensuring the reliability of the transfer detail information generated based on the transaction information and providing an effective basis and convenience for subsequent compliance supervision.

Further, in order for the first user to know a resource transfer result, after S106, the method can further include the following: sending transfer result information of the resource transfer to the first service institution so that the first service institution sends the transfer result information to the first end-user device, and the first end-user device displays the received transfer result information.

In one or more embodiments of the present specification, the resource management institution receives the first transfer indication information sent by the first service institution located in the different country, where the first transfer indication information is sent based on the resource transfer request sent by the first user; generates, based on the transaction information of the first transaction of the first user stored in the accessed first blockchain, the transfer detail information of the resource to be transferred and stores the transfer detail information in the first blockchain to supervise, based on the transfer detail information in the first blockchain, the transfer of the resource to be transferred; and performs the resource transfer based on the first transfer indication information, so as to transfer the resource to be transferred to the target account, where the transaction information is stored in the first blockchain after the consensus verification participated by the resource management institution and the first service institution succeeds. Therefore, various participants in the resource transfer are connected to the first blockchain, and perform the consensus verification on the transaction information of the first transaction of the first user and then store the transaction information in the first blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participants and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

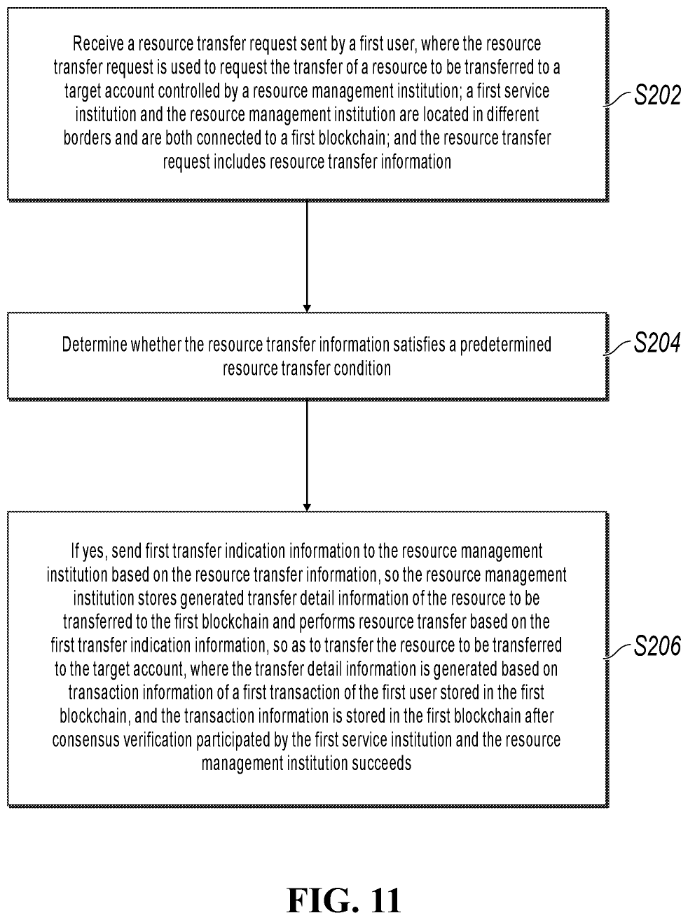

Corresponding to the previously described resource transfer methods in FIG. 3 to FIG. 10, one or more embodiments of the present specification provide another resource transfer method based on the same technical ideal. FIG. 11 is a schematic flowchart illustrating another resource transfer method, according to one or more embodiments of the present specification. The method in FIG. 11 can be performed by the first service institution in FIG. 1. As shown in FIG. 11, the method includes the following steps.

At S202, a resource transfer request sent by a first user is received, where the resource transfer request is used to request the transfer of a resource to be transferred to a target account controlled by a resource management institution; the first service institution and the resource management institution are located in different countries and are both connected to a first blockchain; and the resource transfer request includes resource transfer information, and the resource transfer information includes user identifier information of the first user and a first quantity of the resources to be transferred, etc.

At S204, whether the resource transfer information satisfies a predetermined resource transfer condition is determined.

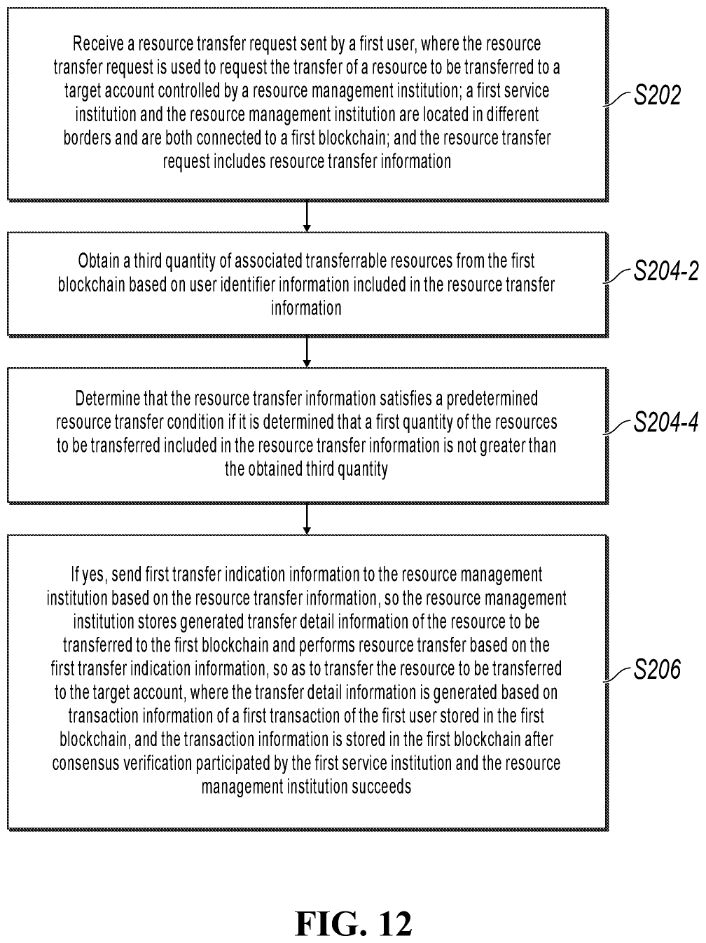

Specifically, as shown in FIG. 12, S204 can include following S204-2 to S204-4:

At S204-2, a third quantity of associated transferrable resources is obtained from the first blockchain based on the user identifier information included in the resource transfer information.

At S204-4, it is determined that the resource transfer information satisfies the predetermined resource transfer condition if it is determined that the first quantity of the resources to be transferred included in the resource transfer information is not greater than the obtained third quantity.

The compliance of the resource transfer is ensured through verification on the quantity of the resources to be transferred.

Further, request failure information is sent to the first user if it is determined that the resource transfer information does not satisfy the predetermined resource transfer condition.

At S206, if yes, first transfer indication information is sent to the resource management institution based on the resource transfer information, so the resource management institution stores generated transfer detail information of the resource to be transferred in the first blockchain and performs resource transfer based on the first transfer indication information, so as to transfer the resource to be transferred to the target account, where the transfer detail information is generated based on transaction information of a first transaction of the first user stored in the first blockchain, and the transaction information is stored in the first blockchain after consensus verification participated by the first service institution and the resource management institution succeeds.

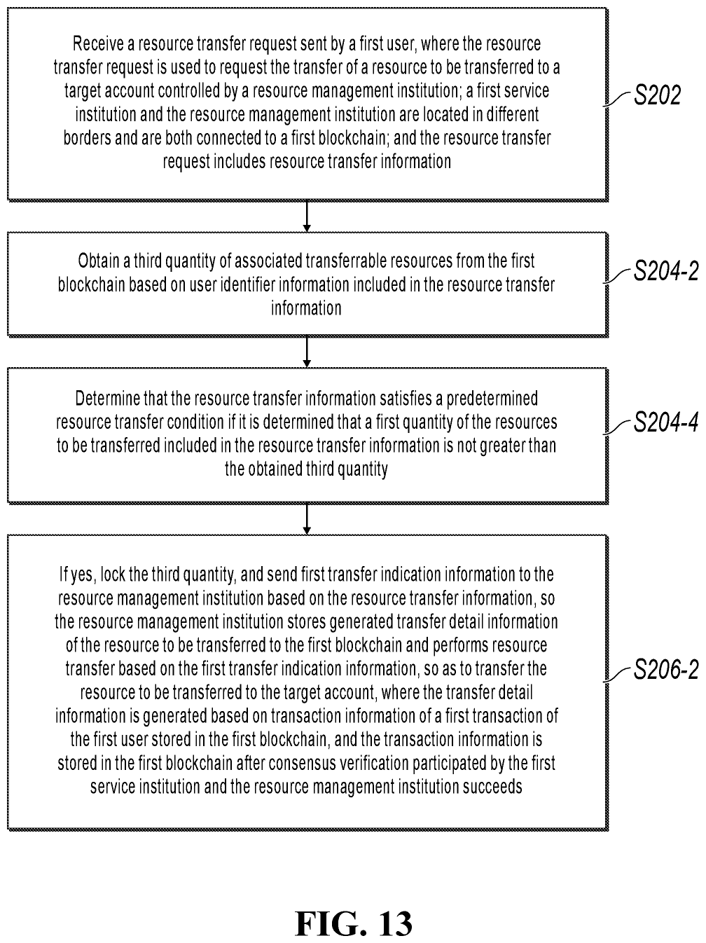

In order to avoid the non-compliance of the resource transfer performed by the fact that the third quantity is changed in other transactions in the process that the resource management institution performs the resource transfer, in one or more embodiments of the present specification, as shown in FIG. 13, S206 can include the following steps.

At S206-2, if yes, the third quantity is locked, and the first transfer indication information is sent to the resource management institution based on the resource transfer information, so the resource management institution stores the generated transfer detail information of the resource to be transferred in the first blockchain and performs the resource transfer based on the first transfer indication information, so as to transfer the resource to be transferred to the target account, where the transfer detail information is generated based on the transaction information of the first transaction of the first user stored in the first blockchain, and the transaction information is stored in the first blockchain after the consensus verification participated by the first service institution and the resource management institution succeeds; and the locked third quantity is updated based on the first quantity of the resources to be transferred after the resource management institution performs the resource transfer based on the first transfer indication information. The specific updating process can refer to the previously described relevant descriptions, and details are omitted here for simplicity.

In practice, the first service institution can obtain the transaction information of the first transaction of the first user. Correspondingly, the method further includes the following: obtaining the transaction information of the first transaction of the first user; and broadcasting the obtained transaction information in the first blockchain so that each node device connected to the first blockchain performs consensus verification on the transaction information based on a predetermined consensus algorithm when obtaining the transaction information, and a node device having a data storage permission stores the transaction information in the blockchain when determining that the consensus verification on the transaction information succeeds.

The way that the first service institution obtains the information of the first transaction of the first user can be set as needed in practice. For example, the first user sends transaction information of first user's first transaction to the first service institution, or the first service institution obtains transaction data, etc. of the first transaction from a transaction platform of the first transaction through a predetermined interface.

In one or more embodiments of the present specification, the first service institution sends, based on the resource transfer information included in the resource transfer request sent by the first user that is used to request the transfer of the resource to be transferred to the target account controlled by the resource management institution located in the different country from the first service institution, the first transfer indication information to the resource management institution when determining that the resource transfer information satisfies the predetermined resource transfer condition, so the resource management institution stores the generated transfer detail information of the resource to be transferred in the first blockchain and performs the resource transfer based on the first transfer indication information, so as to transfer the resource to be transferred to the target account, where the transfer detail information is generated based on the transaction information of the first transaction of the first user stored in the first blockchain, and the transaction information is stored in the first blockchain after the consensus verification participated by the first service institution and the resource management institution succeeds. Therefore, various participants in the resource transfer are connected to the first blockchain, and perform the consensus verification on the transaction information of the first transaction of the firs user and then store the transaction information in the blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participants and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

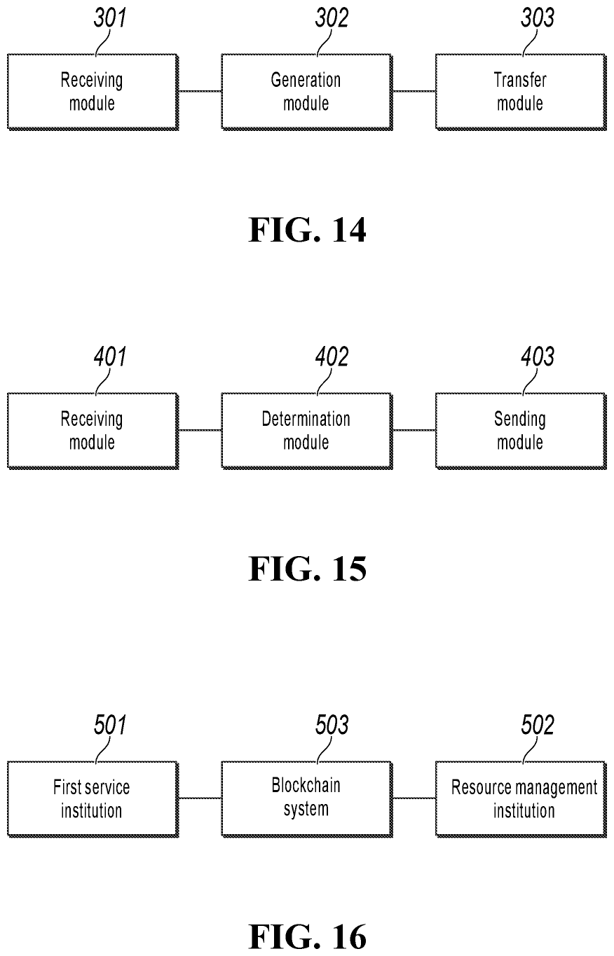

Corresponding to the previously described resource transfer methods in FIG. 3 to FIG. 10, one or more embodiments of the present specification further provide a resource transfer apparatus based on the same technical ideal. FIG. 14 is a schematic diagram illustrating assembly of a resource transfer apparatus, according to one or more embodiments of the present specification. The apparatus is configured to perform the resource transfer methods described in FIG. 3 to FIG. 10. As shown in FIG. 14, the apparatus includes the following: a receiving module 301, configured to receive first transfer indication information sent by a first service institution, where the first transfer indication information is sent based on a resource transfer request sent by a first user when it is determined that a predetermined resource transfer condition is satisfied; the resource transfer request is used to request the transfer of a resource to be transferred to a target account controlled by a resource management institution; and the resource management institution and the first service institution are located in different countries and are both connected to a first blockchain; a generation module 302, configured to generate transfer detail information of the resource to be transferred based on transaction information of a first transaction of the first user stored in the first blockchain, and store the transfer detail information in the first blockchain to supervise, based on the transfer detail information, the transfer of the resource to be transferred, where the transaction information is stored in the first blockchain after consensus verification participated by the resource management institution and the first service institution succeeds; and a transfer module 303, configured to perform resource transfer based on the first transfer indication information, so as to transfer the resource to be transferred to the target account.

Optionally, the generation module 302 is further configured to invoke a first smart contract in the first blockchain, and generate the transfer detail information of the resource to be transferred based on the first smart contract and the transaction information of the first transaction of the first user stored in the first blockchain.

Optionally, the transfer module 303 is further configured to transform, based on a predetermined transformation rule, the resource to be transferred into a second type of resource to be transferred corresponding to the country where the resource management institution is located; transfer the second type of resource to be transferred to a specified intermediate account based on the first transfer indication information; and transfer the second type of resource to be transferred from the intermediate account to the target account.

Optionally, the apparatus further includes a consensus module; where the consensus module is configured to obtain the transaction information of the first transaction, and perform consensus verification on the transaction information based on a predetermined consensus algorithm so that a node device having a data storage permission in the first blockchain stores the transaction information in the first blockchain when determining that the consensus verification on the transaction information succeeds.

The resource transfer apparatus provided by one or more embodiments of the present specification is configured to receive the first transfer indication information sent by the first service institution in the different country, where the first transfer indication information is sent based on the resource transfer request sent by the first user; generate, based on the transaction information of the first transaction of the first user stored in the accessed first blockchain, the transfer detail information of the resource to be transferred and store the transfer detail information in the first blockchain to supervise, based on the transfer detail information in the first blockchain, the transfer of the resource to be transferred; and performs the resource transfer based on the first transfer indication information, so as to transfer the resource to be transferred to the target account, where the transaction information is stored in the first blockchain after the consensus verification participated by the resource management institution and the first service institution succeeds. Therefore, various participants in the resource transfer are connected to the first blockchain, and perform the consensus verification on the transaction information of the first transaction of the first user and then store the transaction information in the blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participants and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

It is worthwhile to note that the embodiments of the resource transfer apparatuses in the present specification and the embodiments of the resource transfer methods in the present specification are based on the same inventive ideal, so that the specific implementations of the embodiments can refer to the implementations of the previously described corresponding resource transfer methods, and repetitions are omitted for simplicity.

Further, corresponding to the previously described resource transfer methods in FIG. 11 to FIG. 13, one or more embodiments of the present specification further provide another resource transfer apparatus based on the same technical ideal. FIG. 15 is a schematic diagram illustrating assembly of another resource transfer apparatus, according to one or more embodiments of the present specification. The apparatus is configured to perform the resource transfer methods described in FIG. 11 to FIG. 13. As shown in FIG. 15, the apparatus includes the following: a receiving module 401, configured to receive a resource transfer request sent by a first user, where the resource transfer request is used to request the transfer of a resource to be transferred to a target account controlled by a resource management institution; the first service institution and the resource management institution are located in different countries and are both connected to a first blockchain; and the resource transfer request includes resource transfer information; a determination module 402, configured to determine whether the resource transfer information satisfies a predetermined resource transfer condition; and a sending module 403, configured to send first transfer indication information to the resource management institution based on the resource transfer information if a determination result of the determination module 402 is yes, so the resource management institution stores generated transfer detail information of the resource to be transferred in the first blockchain and performs resource transfer based on the first transfer indication information, so as to transfer the resource to be transferred to the target account, where the transfer detail information is generated based on transaction information of a first transaction of the first user stored in the first blockchain, and the transaction information is stored in the first blockchain after consensus verification participated by the first service institution and the resource management institution succeeds.

Optionally, the resource transfer information includes user identifier information of the first user and a first quantity of the resources to be transferred.

The determination module 402 is further configured to obtain a third quantity of associated transferrable resources from the first blockchain based on the user identifier information; and determine that the resource transfer information satisfies the predetermined resource transfer condition if it is determined that the first quantity is not greater than the third quantity.

Optionally, the apparatus further includes a locking module, where the locking module is configured to lock the third quantity so that the resource management institution updates the locked third quantity after performing, based on the first transfer indication information, the resource transfer.

The resource transfer apparatus provided by one or more embodiments of the present specification is configured to send, based on the resource transfer information included in the resource transfer request sent by the first user that is used to request the transfer of the resource to be transferred to the target account controlled by the resource management institution located in the different country from the first service institution; the first transfer indication information to the resource management institution when it is determined that the resource transfer information satisfies the predetermined resource transfer condition, so the resource management institution stores the generated transfer detail information of the resource to be transferred in the first blockchain and performs the resource transfer based on the first transfer indication information, so as to transfer the resource to be transferred to the target account, where the transfer detail information is generated based on the transaction information of the first transaction of the first user stored in the first blockchain, and the transaction information is stored in the first blockchain after the consensus verification participated by the first service institution and the resource management institution succeeds. Therefore, various participants in the resource transfer are connected to the first blockchain, and perform the consensus verification on the transaction information of the first transaction of the first user and then store the transaction information in the blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participants and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

It is worthwhile to note that the embodiments of the resource transfer apparatuses in the present specification and the embodiments of the resource transfer methods in the present specification are based on the same inventive ideal, so that the specific implementations of the embodiments can refer to the implementations of the previously described corresponding resource transfer methods, and repetitions are omitted for simplicity.

Further, corresponding to the previously described resource transfer methods, one or more embodiments of the present specification further provide a resource transfer system based on the same technical ideal. FIG. 16 is a schematic diagram illustrating assembly of a resource transfer system, according to one or more embodiments of the present specification. As shown in FIG. 16, the system includes a first service institution 501, a resource management institution 502, and a blockchain system 503, where the first service institution 501 and the resource management institution 502 are located in different countries and are both connected to the blockchain system 503.

The first service institution 501 is configured to receive a resource transfer request sent by a first user, and send first transfer indication information to the resource management institution 502 based on resource transfer information if it is determined that the resource transfer information included in the resource transfer request satisfies a predetermined resource transfer condition, where the resource transfer request is used to request the transfer of a resource to be transferred to a target account controlled by the resource management institution 502.

The resource management institution 502 is configured to receive the first transfer indication information sent by the first service institution 501, generate transfer detail information of the resource to be transferred based on transaction information of a first transaction of the first user stored in the blockchain system 503, store the transfer detail information in the blockchain system 503, and perform resource transfer based on the first transfer indication information, so as to transfer the resource to be transferred to the target account.

The blockchain system 503 is configured to store the transaction information of the first transaction and the transfer detail information.

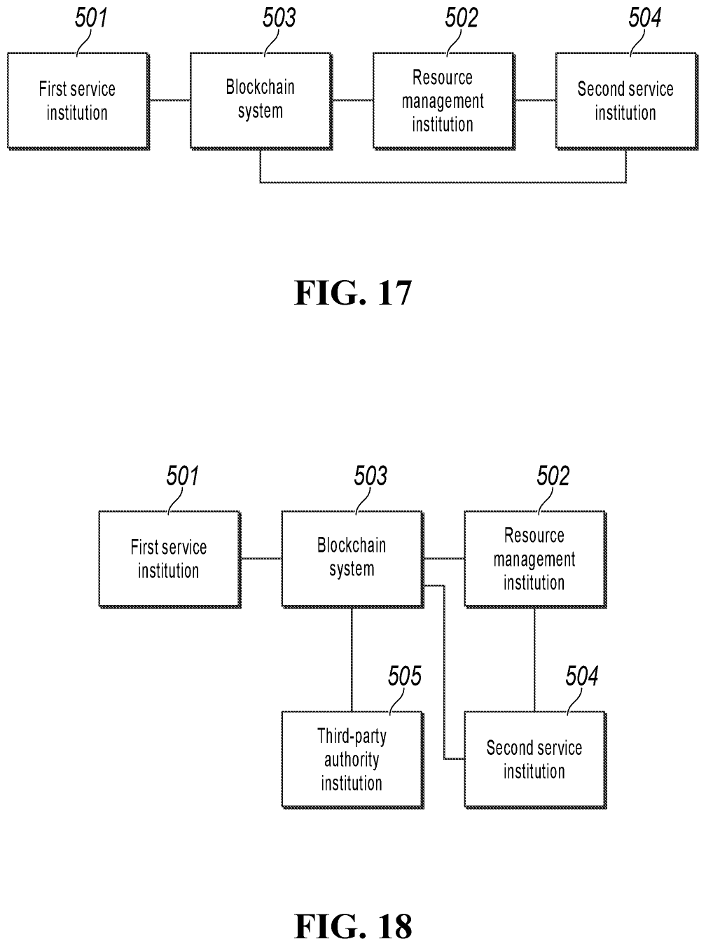

Optionally, as shown in FIG. 17, the system further includes a second service institution 504 located in the same country as the resource management institution 502.

The resource management institution 502 is further configured to transfer the resource to be transferred to a first account of the second service institution 504 based on the first transfer indication information, and send second transfer indication information to the second service institution 504.

The second service institution 504 is connected to the blockchain system 503 and is configured to transfer the resource to be transferred from the first account to the target account based on the second transfer indication information.

Optionally, as shown in FIG. 18, the system further includes a third-party authority institution 505 located in the same country as the resource management institution 502.

The third-party authority institution 505 is connected to the blockchain system 503 and is configured to determine, based on the transfer detail information in the blockchain system 503, whether the resource transfer is valid.

In the resource transfer system provided by one or more embodiments of the present specification, various participants in the resource transfer are connected to the first blockchain, and perform the consensus verification on the transaction information of the first transaction of the first user and then store the transaction information in the first blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participant and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

It is worthwhile to note that the embodiments of the resource transfer systems in the present specification and the embodiments of the resource transfer methods in the present specification are based on the same inventive ideal, so that the specific implementations of the embodiments can refer to the implementations of the previously described corresponding resource transfer methods, and repetitions are omitted for simplicity.

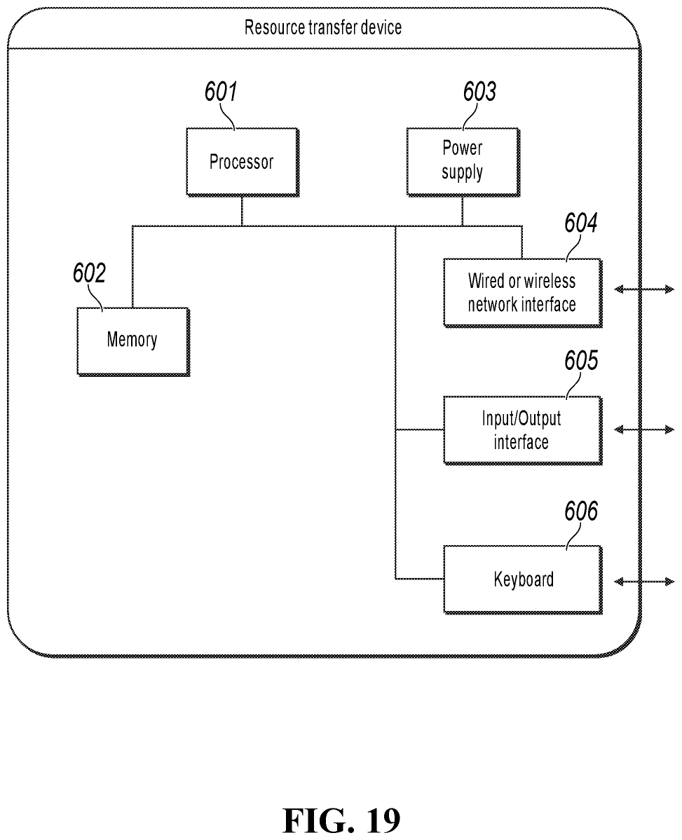

Further, corresponding to the previously described resource transfer methods, one or more embodiments of the present specification further provide a resource transfer device based on the same technical ideal. The device is configured to perform the previously described resource transfer methods. FIG. 19 is a schematic structural diagram illustrating a resource transfer device, according to one or more embodiments of the present specification.

As shown in FIG. 19, the resource transfer device can generate a relatively large difference due to different configurations or performance, and can include one or more processors 601 and memories 602. The Memory 602 can store one or more storage application programs or data. The memory 602 can be a volatile memory or a non-volatile memory. The application program stored in the memory 602 can include one or more modules (not shown in the figure), and each module can include a series of computer-executable instructions in the resource transfer device. Much further, the processor 601 can be configured to communicate with the memory 602, and execute the series of computer-executable instructions in the memory 602 on the resource transfer device. The resource transfer device can further include one or more power supplies 603, one or more wired or wireless network interfaces 604, one or more input/output interfaces 605, one or more keyboards 606, etc.

In one specific embodiment, the resource transfer device includes a memory and one or more programs, where the one or more programs are stored in the memory, and the one or more programs can include one or more modules; each module can include a series of computer-executable instructions in the resource transfer device, and the one or more processors are configured to execute the computer-executable instructions included in the one or more programs, so as to implement the following processes: receiving first transfer indication information sent by a first service institution, where the first transfer indication information is sent based on a resource transfer request sent by a first user when it is determined that a predetermined resource transfer condition is satisfied; the resource transfer request is used to request the transfer a resource to be transferred to a target account controlled by a resource management institution; and the resource management institution and the first service institution are located in different countries and are both connected to a first blockchain; generating, based on transaction information of a first transaction of the first user stored in the first blockchain, transfer detail information of the resource to be transferred, and storing the transfer detail information in the first blockchain to supervise, based on the transfer detail information, the transfer of the resource to be transferred, where the transaction information is stored in the first blockchain after consensus verification participated by the resource management institution and the first service institution succeeds; and performing resource transfer based on the first transfer indication information, so as to transfer the resource to be transferred to the target account.

Optionally, when the computer-executable instructions are executed, the generating, based on transaction information of a first transaction of the first user stored in the first blockchain, transfer detail information of the resource to be transferred includes the following: invoking a first smart contract in the first blockchain, and generating, based on the first smart contract and the transaction information of the first transaction of the first user stored in the first blockchain, the transfer detail information of the resource to be transferred.

Optionally, when the computer-executable instructions are executed, and when the resource to be transferred is a first type of resource, the performing resource transfer based on the first transfer indication information includes the following: transforming, based on a predetermined conversion rule, the resource to be transferred into a second type of resource to be transferred corresponding to the country where the resource management institution is located; transferring the second type of resource to be transferred to a specified intermediate account based on the first transfer indication information; and transferring the second type of resource to be transferred from the intermediate account to the target account.

Optionally, the computer-executable instructions, when executed, further implement the following processes: obtaining the transaction information of the first transaction of the first user, and performing consensus verification on the transaction information based on a predetermined consensus algorithm so that a node device having a data storage permission in the first blockchain stores the transaction information in the first blockchain when determining that the consensus verification on the transaction information succeeds.

The resource transfer device provided by one or more embodiments of the present specification is configured to receive the first transfer indication information sent by the first service institution in the different country, where the first transfer indication information is sent based on the resource transfer request sent by the first user; generate, based on the transaction information of the first transaction of the first user stored in the accessed first blockchain, the transfer detail information of the resource to be transferred and store the transfer detail information in the first blockchain to supervise, based on the transfer detail information in the first blockchain, the transfer of the resource to be transferred; and perform the resource transfer based on the first transfer indication information, so as to transfer the resource to be transferred to the target account, where the transaction information is stored in the first blockchain after the consensus verification participated by the resource management institution and the first service institution succeeds. Therefore, various participants in the resource transfer are connected to the first blockchain, and perform the consensus verification on the transaction information of the first transaction of the first user and then store the transaction information in the first blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participant and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

In another specific embodiment, the resource transfer device includes a memory and one or more programs, where the one or more programs are stored in the memory, and the one or more programs can include one or more modules; each module can include a series of computer-executable instructions in the resource transfer device, and the one or more processors are configured to execute the computer-executable instructions included in the one or more programs, so as to implement the following processes: receiving a resource transfer request sent by a first user, where the resource transfer request is used to request the transfer of a resource to be transferred to a target account controlled by a resource management institution; the first service institution and the resource management institution are located in different countries and are both connected to a first blockchain; and the resource transfer request includes resource transfer information; determining whether the resource transfer information satisfies a predetermined resource transfer condition; and if yes, sending first transfer indication information to the resource management institution based on the resource transfer information, so the resource management institution stores generated transfer detail information of the resource to be transferred in the first blockchain and performs resource transfer based on the first transfer indication information, so as to transfer the resource to be transferred to the target account, where the transfer detail information is generated based on transaction information of a first transaction of the first user stored in the first blockchain, and the transaction information is stored in the first blockchain after consensus verification participated by the first service institution and the resource management institution succeeds.

Optionally, when the computer-executable instructions are executed, the resource transfer information includes user identifier information of the first user and a first quantity of the resources to be transferred; and the determining whether the resource transfer information satisfies a predetermined resource transfer condition includes the following: obtaining a third quantity of associated transferrable resources from the first blockchain based on the user identifier information; and determining that the resource transfer information satisfies the predetermined resource transfer condition if it is determined that the first quantity is not greater than the third quantity.

Optionally, when the computer-executable instructions are executed, the determining that the resource transfer information satisfies the predetermined resource transfer condition further includes the following: locking the third quantity so that the resource management institution updates the locked third quantity after performing, based on the first transfer indication information, the resource transfer.

The resource transfer device provided by one or more embodiments of the present specification is configured to send, based on the resource transfer information included in the resource transfer request sent by the first user that is used to request the transfer of the resource to be transferred to the target account controlled by the resource management institution in the different country from the first service institution; the first transfer indication information to the resource management institution when it is determined that the resource transfer information satisfies the predetermined resource transfer condition, so the resource management institution stores the generated transfer detail information of the resource to be transferred in the first blockchain and performs the resource transfer based on the first transfer indication information, so as to transfer the resource to be transferred to the target account, where the transfer detail information is generated based on the transaction information of the first transaction of the first user stored in the first blockchain, and the transaction information is stored in the first blockchain after the consensus verification participated by the first service institution and the resource management institution succeeds. Therefore, various participants in the resource transfer are connected to the first blockchain, and perform the consensus verification on the transaction information of the first transaction of the first user and then store the transaction information in the first blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participant and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

It is worthwhile to note that the embodiments of the resource transfer devices in the present specification and the embodiments of the resource transfer methods in the present specification are based on the same inventive ideal, so that the specific implementations of the embodiments can refer to the implementations of the previously described corresponding resource transfer methods, and repetitions are omitted for simplicity.

Further, corresponding to the previously described resource transfer methods, one or more embodiments of the present specification further provide, based on the same technical ideal, a storage medium configured to store computer-executable instructions. In one specific embodiment, the storage medium can be a USB flash disk, an optical disk, a hard disk, etc. The computer-executable instructions stored in the storage medium, when executed by a processor, can implement the following processes: receiving first transfer indication information sent by a first service institution, where the first transfer indication information is sent based on a resource transfer request sent by a first user when it is determined that a predetermined resource transfer condition is satisfied; the resource transfer request is used to request the transfer of a resource to be transferred to a target account controlled by a resource management institution; and the resource management institution and the first service institution are located in different countries and are both connected to a first blockchain; generating, based on transaction information of a first transaction of the first user stored in the first blockchain, transfer detail information of the resource to be transferred, and storing the transfer detail information in the first blockchain to supervise, based on the transfer detail information, the transfer of the resource to be transferred, where the transaction information is stored in the first blockchain after consensus verification participated by the resource management institution and the first service institution succeeds; and performing resource transfer based on the first transfer indication information, so as to transfer the resource to be transferred to the target account.

Optionally, when the computer-executable instructions stored in the storage medium are executed by the processor, the generating, based on transaction information of a first transaction of the first user stored in the first blockchain, the transfer detail information of the resource to be transferred includes the following: invoking a first smart contract in the first blockchain, and generating, based on the first smart contract and the transaction information of the first transaction of the first user stored in the first blockchain, the transfer detail information of the resource to be transferred.

Optionally, when the computer-executable instructions stored in the storage medium are executed by the processor, the resource to be transferred is a first type of resource, and the performing resource transfer based on the first transfer indication information includes the following: transforming, based on a predetermined conversion rule, the resource to be transferred into a second type of resource to be transferred corresponding to the country where the resource management institution is located; transferring, based on the first transfer indication information, the second type of resource to be transferred to a specified intermediate account; and transferring the second type of resource to be transferred from the intermediate account to the target account.

Optionally, when the computer-executable instructions stored in the storage medium are executed by the processor, the method further includes the following: obtaining the transaction information of the first transaction of the first user, and performing consensus verification on the transaction information based on a predetermined consensus algorithm so that a node device having a data storage permission in the first blockchain stores the transaction information in the first blockchain when it is determined that the consensus verification on the transaction information succeeds.

The computer-executable instructions stored in the storage medium that is provided by one or more embodiments of the present specification, when executed by the processor, implement the following processes: receiving the first transfer indication information sent by the first service institution in the different country, where the first transfer indication information is sent based on the resource transfer request sent by the first user; generating, based on the transaction information of the first transaction of the first user stored in the accessed first blockchain, the transfer detail information of the resource to be transferred and storing the transfer detail information in the first blockchain to supervise, based on the transfer detail information in the first blockchain, the transfer of the resource to be transferred; and performing the resource transfer based on the first transfer indication information, so as to transfer the resource to be transferred to the target account, where the transaction information is stored in the first blockchain after the consensus verification participated by the resource management institution and the first service institution succeeds. Therefore, various participants in the resource transfer are connected to the first blockchain, and perform the consensus verification on the transaction information of the first transaction of the first user and then store the transaction information in the first blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participant and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

In another specific embodiment, the storage medium can be a USB flash disk, an optical disk, a hard disk, etc. The computer-executable instructions stored in the storage medium, when executed by a processor, can implement the following processes: receiving a resource transfer request sent by a first user, where the resource transfer request is used to request the transfer of a resource to be transferred to a target account controlled by a resource management institution; the first service institution and the resource management institution are located in different countries and are both connected to a first blockchain; and the resource transfer request includes resource transfer information; determining whether the resource transfer information satisfies a predetermined resource transfer condition is determined; and if yes, sending first transfer indication information to the resource management institution based on the resource transfer information, so the resource management institution stores generated transfer detail information of the resource to be transferred in the first blockchain and performs resource transfer based on the first transfer indication information, so as to transfer the resource to be transferred to the target account, where the transfer detail information is generated based on transaction information of a first transaction of the first user stored in the first blockchain, and the transaction information is stored in the first blockchain after consensus verification participated by the first service institution and the resource management institution succeeds.

Optionally, when the computer-executable instructions stored in the storage medium are executed by the processor, the resource transfer information includes user identifier information of the first user and a first quantity of the resource to be transferred; and the determining whether the resource transfer information satisfies a predetermined resource transfer condition includes the following: obtaining a third quantity of associated transferrable resources from the first blockchain based on the user identifier information; and determining that the resource transfer information satisfies the predetermined resource transfer condition if it is determined that the first quantity is not greater than the third quantity.

Optionally, when the computer-executable instructions stored in the storage medium are executed by the processor, the determining that the resource transfer information satisfies the predetermined resource transfer condition further includes the following: locking the third quantity so that the resource management institution updates the locked third quantity after performing, based on the first transfer indication information, the resource transfer.

The computer-executable instructions stored in the storage medium that is provided by one or more embodiments of the present specification, when executed by the processor, implement the following processes: sending the first transfer indication information, based on the resource transfer information included in the resource transfer request sent by the first user that is used to request the transfer of the resource to be transferred to the target account controlled by the resource management institution in the different country from the first service institution, to the resource management institution when it is determined that the resource transfer information satisfies the predetermined resource transfer condition, so the resource management institution stores the generated transfer detail information of the resource to be transferred in the first blockchain and performs the resource transfer based on the first transfer indication information, so as to transfer the resource to be transferred to the target account, where the transfer detail information is generated based on the transaction information of the first transaction of the first user stored in the first blockchain, and the transaction information is stored in the first blockchain after the consensus verification participated by the first service institution and the resource management institution succeeds. Therefore, various participants in the resource transfer are connected to the first blockchain, and perform the consensus verification on the transaction information of the first transaction of the first user and then store the transaction information in the first blockchain before the first user initiates the resource transfer request. Therefore, the time cost required by transmitting data such as the transaction information layer by layer between the various participants is reduced, and additional operations such as verification performed by the layer-by-layer data transmission between the various participants are reduced, thereby reducing the data processing cost of the various participant and improving the processing efficiency of resource transfer; moreover, the transfer detail information can be fast generated based on the transaction information in the blockchain, ensuring the timeliness; and furthermore, the transaction information is stored in the first blockchain after the consensus verification to ensure the authenticity and reliability of the transaction information, thereby ensuring the reliability of the transfer detail information generated based on the transaction information and providing an effective basis and convenience for subsequent compliance supervision.

It is worthwhile to note that the embodiments of the storage media in the present specification and the embodiments of the resource transfer methods in the present specification are based on the same inventive ideal, so that the specific implementations of the embodiments can refer to the implementations of the previously described corresponding resource transfer methods, and repetitions are omitted for simplicity.

The previous content describes the specific embodiments of the present specification. Other embodiments fall within the scope of the appended claims. In some cases, the actions or steps described in the claims can be performed in a different country than in the embodiments and still achieve desired results. In addition, the processes depicted in the drawings can achieve the desired results without necessarily requiring the specific order or sequential order shown. In some implementations, multitasking and parallel processing are also possible or may be advantageous.

In the 1990s, the improvement on a technology can be clearly distinguished between hardware improvements (for example, improvements of circuit structures such as diodes, transistors and switches) or software improvements (improvements of method flow). However, with the development of technologies, the improvements on many current method flow can be regarded as direct improvements on hardware circuit structures. Designers almost always obtain corresponding hardware circuit structures by programming improved method flow to hardware circuits. Therefore, it cannot be said that the improvement on one method flow cannot be realized by a hardware entity module. For example, a programmable logic device (PLD) (such as a field programmable gate array (FPGA)) is an integrated circuit including a logic function that is determined by user's programming of the device. It is programmed by the designer to “integrate” one digital system on one PLD without hiring a chip manufacturer to design and manufacture a dedicated integrated circuit chip. Moreover, nowadays, instead of manual manufacturing of integrated circuit chips, this programming is mostly realized by using “logic compiler” software that is similar to software compiler used in program development and writing, but original codes before compiling must also be written in a specific programming language. This is called hardware description language (HDL). There are many HDLs, such as advanced boolean expression language (ABEL), Altera hardware description language (AHDL), confluence, Cornell University programming language (CUPL), HDCal, Java hardware description language (JHDL), Lava, Lola, MyHDL, PALASM, and ruby hardware description language (RHDL). Very-high-speed integrated circuit hardware description language (VHDL) and Verilog are used most at the present. It should also be clear to those skilled in the art that just a little bit of logic programming of the method flow in the previously described several hardware description languages and programming into an integrated circuit can easily obtain hardware circuits that implement the logic method flow.

The controller can be implemented in any suitable manner. For example, the controller can use the form of, for example, a microprocessor or a processor and a computer-readable medium that stores computer-readable program codes (such as software or firmware) executable by the (micro) processor, a logic gate, a switch, an application specific integrated circuit (ASIC), a programmable logic controller and an embedded microcontroller. Examples of the controller include, but are not limited to, the following microcontrollers: ARC 625D, Atmel AT91SAM, Microchip PIC18F26K20 and Silicon Labs C8051F320. A memory controller can also be implemented as part of a control logic of a memory. Those skilled in the art also know that the controller can absolutely realize the same functions in the form of the logic gate, the switch, the ASIC, the programmable logic controller, the embedded microcontroller, etc. by means of logically programming the steps of the methods in addition to implementing the controller in a manner of pure computer-readable program codes. Therefore, such a controller can be regarded as a hardware component, and the apparatuses included in it to realize the various functions can also be regarded as structures within the hardware component. Or even, the apparatuses configured to realize the various functions can be regarded as both a software module for realizing the method and a structure within the hardware component.

The systems, apparatuses, modules, or units explained in the previously described embodiments can be implemented by computer chips or entities, or implemented by products with certain functions. A typical implementation device is a computer. Specifically, the computer may be, for example, a personal computer, a laptop computer, a cell phone, a camera phone, a smart phone, a personal digital assistant, a media player, a navigation device, an email device, a game console, a tablet computer, a wearable device, or a combination of any of these devices.

For convenience of description, the above apparatuses are divided into various units for respectively description based on their functions. Of course, the functions of the various units may be implemented in at least the same or more software or hardware during implementation of the embodiments of present specification.

Those skilled in the art should understand that one or more embodiments of the present specification may provide methods, systems or computer program products. Therefore, one or more embodiments of the present specification can use the form of complete hardware embodiments, complete software embodiments, or software and hardware combination embodiments. In addition, the present specification can use the form of a computer program product implemented on one or more computer-sensitive storage media (including, but not limited to, a magnetic disk memory, a compact disc read-only memory (CD-ROM), an optical memory, etc.) containing computer-sensitive program codes.

The present specification is described by referring to at least the flow diagrams or block diagrams of methods, devices (systems) and computer program products according to the embodiments of the present specification. It should be understood that computer program instructions can implement at least each flow or each block in at least the flowcharts or the block diagrams and combination of at least the flows or the blocks in at least the flowcharts or the block diagrams. These computer program instructions can be provided for a general computer, a dedicated computer, an embedded processor or processing units of other programmable data processing devices to generate a machine, thereby making the instructions that are executed by the computer or the processing units of other programmable data processing devices generate apparatuses for realizing specified functions in at least one of the following one or more flow of the flowcharts or one or more blocks of the block diagrams.

These computer program instructions also can be stored in a computer-readable memory capable of guiding the computer or other programmable data processing devices to work in a specific manner, thereby making the instructions that are stored in the computer readable memory generate manufactured products that include instruction apparatuses. The instruction apparatuses realize the specified functions in at least one of the following: one or more flow of the flowcharts or one or more blocks of the block diagrams.

These computer program instructions also can be loaded onto the computer or other programmable data processing devices to execute a series of operation steps on the computer or other programmable data processing devices to generate computer implemented processing, so that the instructions executed on the computer or other programmable data processing devices provide steps for realizing the specified functions in at least one of the following: one or more flow of the flowchart or one or more blocks of the block diagrams.

In one typical configuration, a computing device includes one or more central processing units (CPU), input/output interfaces, network interfaces and internal memories.

The internal memory may include at least one of a volatile memory in a computer-readable medium, a random access memory (RAM) or a non-volatile memory, etc., such as a read-only memory (ROM) or a flash RAM. The internal memory is an example of computer-readable media.

The computer-readable media include non-volatile and volatile, removable and non-removable media, and information storage can be realized by any method or technology. The information can be computer-readable instructions, data structures, program modules, or other data. Examples of the computer storage media include, but are not limited to, a phase change random access memory (PRAM), a static random access memory (SRAM), a dynamic random access memory (DRAM), other types of RAMs, a ROM, an electrically erasable programmable read-only memory (EEPROM), a flash memory or other memory technologies, a compact disk read only memory (CD-ROM), a digital versatile disc (DVD) or other optical storages, a magnetic cassette, a magnetic tape magnetic disk storage or other magnetic storage devices or any other non-transmission media, and can be configured to store information that can be accessed by computing devices. As described in this application, the computer-readable media do not include transitory media, such as modulated data signals and carriers.

It is also worthwhile to note that terms “include”, “contain” or any other variants of them are meant to cover non-exclusive inclusions, so that a process, method, product or device that includes a series of elements not only includes those elements, but also includes other elements which are not definitely listed, or further includes inherent elements of this process, method, product or device. Elements described by a sentence “includes a/an . . . ” do not exclude that the processes, methods, products or devices that include the elements still include other identical elements without more restrictions.

One or more embodiments of the present specification can be described in the general context of the computer-executable instructions executed by a computer, such as program modules. Generally, the program modules include routines, programs, objects, components, data structures, etc. that perform specific tasks or implement specific abstract data types. One or more embodiments of the present specification can also be practiced in distributed computing environments. In these distributed computing environments, tasks are performed by remote processing devices connected through a communications network. In the distributed computing environments, program modules can be located in local and remote computer storage media including storage devices.

The various embodiments in the present specification are described in a progressive manner, and the same or similar parts between the various embodiments can refer to each other, and each embodiment focuses on the differences from other embodiments. In particular, as for the system embodiments, since they are basically similar to the method embodiments, the description is relatively simple, and related parts refer to part of the descriptions of the method embodiments.

The above contents are only the embodiments of the present specification, but not intended to limit the present specification. Those skilled in the art can make various changes and variations to the present specification. Any modifications, equivalent replacements, improvements, etc. that are made without departing from the spirit and the principle of the present specification shall all fall within the scope of the claims of the present specification.

What is claimed is:

1. A computer-implemented method comprising:
receiving, by a resource management institution, first transfer indication information from a first service institution, wherein the first transfer indication information is based on a resource transfer request of a user, wherein the resource transfer request requests a transfer of a resource to a target account controlled by the resource management institution, and wherein the resource management institution and the first service institution are connected to a blockchain;
generating transfer information of the resource based on transaction information of a transaction of the user stored on the blockchain;
in response to determining that a consensus on the transfer information succeeds, storing the transfer information on the blockchain, wherein participants of the consensus comprise the resource management institution and the first service institution; and
transferring, based on the first transfer indication information, the resource to the target account.

2. The computer-implemented method of claim 1, wherein the resource is a first type of resource, the first transfer indication information comprises a first quantity of the first type of resource, each transaction of a plurality of transactions is associated with a respective quantity of the first type of resource received by the user in a corresponding transaction, and wherein generating the transfer information of the resource comprises:
identifying, based on the first quantity and respective quantity of each transaction of the plurality of transactions, one or more transactions of the plurality of transactions; and
generating the transfer information of the resource based on transaction information of the one or more transactions, wherein the transaction information of the one or more transactions is stored on the blockchain.

3. The computer-implemented method of claim 1, wherein the resource is a first type of resource, the first transfer indication information comprises a first quantity of the first type of resource and transaction identifier information of one or more transactions, wherein generating the transfer information of the resource comprises:
obtaining, based on the transaction identifier information and from the blockchain, transaction information of the one or more transactions, wherein the transaction information of the one or more transactions indicates a total quantity of the first type of resource of the one or more transactions; and
in response to determining that the total quantity is not less than the first quantity, generating the transfer information of the resource.

4. The computer-implemented method of claim 1, wherein the resource management institution and the first service institution are located in different countries, wherein the resource is a first type of resource, and wherein transferring the resource comprises:
exchanging, based on a predetermined exchange rule, the resource into a second type of resource corresponding to a country where the resource management institution is located;
transferring the second type of resource to an intermediate account based on the first transfer indication information; and
transferring the second type of resource from the intermediate account to the target account.

5. The computer-implemented method of claim 4, wherein transferring the second type of resource to the intermediate account comprises:
transferring the second type of resource to an account of a second service institution located in a same country as the resource management institution, and sending second transfer indication information to the second service institution, wherein the second service institution transfers the second type of resource from the account of the second service institution to the target account based on the second transfer indication information; or
transferring the second type of resource to a second account of the resource management institution, and transferring the second type of resource from the second account to the target account.

6. The computer-implemented method of claim 1, wherein the first transfer indication information comprises a quantity of the resource and user identifier information of the user, wherein the computer-implemented method further comprises, after storing the transfer information on the blockchain:
obtaining a quantity of transferrable resource from the blockchain based on the user identifier information;
determining an updated quantity of transferrable resource based on the quantity of the resource and the quantity of transferrable resource; and
storing the updated quantity of transferrable resource on the blockchain associated with the user identifier information.

7. The computer-implemented method of claim 1, further comprising:
in response to determining that the transaction information of the transaction satisfies a predetermined storage condition, signing the transaction information of the transaction based on a private key of the resource management institution to obtain signature data;
sending the signature data and institution identifier information of the resource management institution to one or more blockchain nodes of the blockchain;
receiving additional signature data and node identifier information from the one or more blockchain nodes;
obtaining one or more public key based on the node identifier information;
verifying, based on the one or more public key, the additional signature data; and
in response to determining that the additional signature data is verified, determining, based on a consensus algorithm, that a consensus on the transaction information of the transaction succeeds.

8. A non-transitory, computer-readable medium storing one or more instructions executable by a computer system to perform operations comprising:
receiving, by a resource management institution, first transfer indication information from a first service institution, wherein the first transfer indication information is based on a resource transfer request of a user, wherein the resource transfer request requests a transfer of a resource to a target account controlled by the resource management institution, and wherein the resource management institution and the first service institution are connected to a blockchain;
generating transfer information of the resource based on transaction information of a transaction of the user stored on the blockchain;
in response to determining that a consensus on the transfer information succeeds, storing the transfer information on the blockchain, wherein participants of the consensus comprise the resource management institution and the first service institution; and
transferring, based on the first transfer indication information, the resource to the target account.

9. The non-transitory, computer-readable medium of claim 8, wherein the resource is a first type of resource, the first transfer indication information comprises a first quantity of the first type of resource, each transaction of a plurality of transactions is associated with a respective quantity of the first type of resource received by the user in a corresponding transaction, and wherein generating the transfer information of the resource comprises:
identifying, based on the first quantity and respective quantity of each transaction of the plurality of transactions, one or more transactions of the plurality of transactions; and
generating the transfer information of the resource based on transaction information of the one or more transactions, wherein the transaction information of the one or more transactions is stored on the blockchain.

10. The non-transitory, computer-readable medium of claim 8, wherein the resource is a first type of resource, the first transfer indication information comprises a first quantity of the first type of resource and transaction identifier information of one or more transactions, wherein generating the transfer information of the resource comprises:
obtaining, based on the transaction identifier information and from the blockchain, transaction information of the one or more transactions, wherein the transaction information of the one or more transactions indicates a total quantity of the first type of resource of the one or more transactions; and
in response to determining that the total quantity is not less than the first quantity, generating the transfer information of the resource.

11. The non-transitory, computer-readable medium of claim 8, wherein the resource management institution and the first service institution are located in different countries, wherein the resource is a first type of resource, and wherein transferring the resource comprises:
exchanging, based on a predetermined exchange rule, the resource into a second type of resource corresponding to a country where the resource management institution is located;
transferring the second type of resource to an intermediate account based on the first transfer indication information; and
transferring the second type of resource from the intermediate account to the target account.

12. The non-transitory, computer-readable medium of claim 11, wherein transferring the second type of resource to the intermediate account comprises:
transferring the second type of resource to an account of a second service institution located in a same country as the resource management institution, and sending second transfer indication information to the second service institution, wherein the second service institution transfers the second type of resource from the account of the second service institution to the target account based on the second transfer indication information; or
transferring the second type of resource to a second account of the resource management institution, and transferring the second type of resource from the second account to the target account.

13. The non-transitory, computer-readable medium of claim 8, wherein the first transfer indication information comprises a quantity of the resource and user identifier information of the user, wherein the operations further comprise, after storing the transfer information on the blockchain:
obtaining a quantity of transferrable resource from the blockchain based on the user identifier information;
determining an updated quantity of transferrable resource based on the quantity of the resource and the quantity of transferrable resource; and
storing the updated quantity of transferrable resource on the blockchain associated with the user identifier information.

14. The non-transitory, computer-readable medium of claim 8, the operations further comprising:
in response to determining that the transaction information of the transaction satisfies a predetermined storage condition, signing the transaction information of the transaction based on a private key of the resource management institution to obtain signature data;
sending the signature data and institution identifier information of the resource management institution to one or more blockchain nodes of the blockchain;
receiving additional signature data and node identifier information from the one or more blockchain nodes;
obtaining one or more public key based on the node identifier information;
verifying, based on the one or more public key, the additional signature data; and
in response to determining that the additional signature data is verified, determining, based on a consensus algorithm, that a consensus on the transaction information of the transaction succeeds.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a resource management institution, first transfer indication information from a first service institution, wherein the first transfer indication information is based on a resource transfer request of a user, wherein the resource transfer request requests a transfer of a resource to a target account controlled by the resource management institution, and wherein the resource management institution and the first service institution are connected to a blockchain;
generating transfer information of the resource based on transaction information of a transaction of the user stored on the blockchain;
in response to determining that a consensus on the transfer information succeeds, storing the transfer information on the blockchain, wherein participants of the consensus comprise the resource management institution and the first service institution; and
transferring, based on the first transfer indication information, the resource to the target account.

16. The computer-implemented system of claim 15, wherein the resource is a first type of resource, the first transfer indication information comprises a first quantity of the first type of resource, each transaction of a plurality of transactions is associated with a respective quantity of the first type of resource received by the user in a corresponding transaction, and wherein generating the transfer information of the resource comprises:
identifying, based on the first quantity and respective quantity of each transaction of the plurality of transactions, one or more transactions of the plurality of transactions; and
generating the transfer information of the resource based on transaction information of the one or more transactions, wherein the transaction information of the one or more transactions is stored on the blockchain.

17. The computer-implemented system of claim 15, wherein the resource is a first type of resource, the first transfer indication information comprises a first quantity of the first type of resource and transaction identifier information of one or more transactions, wherein generating the transfer information of the resource comprises:
obtaining, based on the transaction identifier information and from the blockchain, transaction information of the one or more transactions, wherein the transaction information of the one or more transactions indicates a total quantity of the first type of resource of the one or more transactions; and
in response to determining that the total quantity is not less than the first quantity, generating the transfer information of the resource.

18. The computer-implemented system of claim 15, wherein the resource management institution and the first service institution are located in different countries, wherein the resource is a first type of resource, and wherein transferring the resource comprises:
exchanging, based on a predetermined exchange rule, the resource into a second type of resource corresponding to a country where the resource management institution is located;
transferring the second type of resource to an intermediate account based on the first transfer indication information; and
transferring the second type of resource from the intermediate account to the target account.

19. The computer-implemented system of claim 18, wherein transferring the second type of resource to the intermediate account comprises:
transferring the second type of resource to an account of a second service institution located in a same country as the resource management institution, and sending second transfer indication information to the second service institution, wherein the second service institution transfers the second type of resource from the account of the second service institution to the target account based on the second transfer indication information; or
transferring the second type of resource to a second account of the resource management institution, and transferring the second type of resource from the second account to the target account.

20. The computer-implemented system of claim 15, wherein the first transfer indication information comprises a quantity of the resource and user identifier information of the user, wherein the operations further comprise, after storing the transfer information on the blockchain:
obtaining a quantity of transferrable resource from the blockchain based on the user identifier information;
determining an updated quantity of transferrable resource based on the quantity of the resource and the quantity of transferrable resource; and
storing the updated quantity of transferrable resource on the blockchain associated with the user identifier information.
